(19) United States
(12) Patent Application Publication
(10) Pub. No.: US 2016/0028585 A1
(43) Pub. Date: Jan. 28, 2016

(54) A Master and Second Evolved Node B and Method Performed Thereby for Modifying a Radio Resource of the SENB with Respect to a UE Currently Being Connected to the MENB

(71) Applicant: TELEFONAKTIEBOLAGET L M ERICSSON (PUBL), Stockholm (SE)

(72) Inventors: Stefan Wager, ESPOO (FI); Fredrik GUNNARSSON, LINKÖPING (SE); Riikka SUSITAIVAL, HELSINKI (FI); Alexander VESELY, FELDBACH (AT)

(21) Appl. No.: 14/430,402

(22) PCT Filed: Jan. 14, 2015
(86) PCT No.: PCT/SE2015/050026

§ 371 Date: Mar. 23, 2015

Related U.S. Application Data
(60) Provisional application No. 61/934,334, filed on Jan. 31, 2014.

(51) Int. Cl. H04L 12/24; H04W 72/08

(52) U.S. Cl. CPC H04L 41/0813; H04W 72/085

(57) ABSTRACT

A MeNB and a SeNB and respective methods performed thereby for modifying a radio resource of the SeNB with respect to a UE currently being connected to the MeNB are provided. The MeNB and SeNB are operable in a wireless communication system, the wireless communication system being adapted to provide for dual connectivity between the UE and the MeNB, and the UE and the SeNB. By modifying means changing an existing radio resource configuration or adding a RAB between the SeNB and the UE. The method comprises transmitting (2310), to the SeNB, a request for radio resource modification with regards to an SeNB radio resource configuration between the SeNB and the UE, the request comprising a target MeNB radio resource configuration; and receiving (2320), from the SeNB, the SeNB radio resource configuration with regards to the radio resource between the SeNB and the UE.

### TECHNICAL FIELD

The present disclosure relates to wireless communication and in particular to radio resource configuration negotiations for dual connectivity setup

### BACKGROUND

In a typical cellular radio system, wireless terminals (also referred to as user equipment unit nodes, UEs, mobile terminals, and/or mobile stations) communicate via a radio access network, RAN, with one or more core networks, which provide access to data networks, such as the Internet, and/or the public-switched telecommunications network, PSTN. The RAN covers a geographical area that is divided into cell areas, with each cell area being served by a radio base station (also referred to as a base station, a RAN node, a “NodeB”, and/or enhanced NodeB “eNodeB” or “eNB”). A cell area is a geographical area where radio coverage is provided by the base station equipment at a base station site. The base stations communicate through radio communication channels with wireless terminals within range of the base stations.

Cellular communications system operators have begun offering mobile broadband data services based on, for example, Wideband Code Division Multiple Access, WCDMA, High Speed Packet Access, HSPA, and Long Term Evolution, LTE, wireless technologies. Moreover, fuelled by introduction of new devices designed for data applications, end user performance requirements are steadily increasing. The increased adoption of mobile broadband has resulted in significant growth in traffic handled by high-speed wireless data networks. Accordingly, techniques that allow cellular operators to manage networks more efficiently are desired.

Techniques to improve downlink performance may include 4-branch MIMO, multi-flow communication, multi carrier deployment, etc. Since spectral efficiencies per link may be approaching theoretical limits, next steps may include improving spectral efficiencies per unit area. Further efficiencies for wireless networks may be achieved, for example, by changing a topology of traditional networks to provide increased uniformity of user experiences throughout a cell. Currently, so-called heterogeneous networks are being developed for 3GPP as discussed, for example, in: RP-121436, Study on UMTS Heterogeneous Networks, TSG RAN Meeting #57, Chicago, USA, 4^{th}-7^{th} Sep. 2012; R1-124512, Initial considerations on Heterogeneous Networks for UMTS, Ericsson, ST-Ericsson, 3GOO TSG RAN WG1 Meeting #70bis, San Diego, Calif., USA, 8^{th}-12^{th} Oct. 2012; and R1-124513, Heterogeneous Network Deployment Scenarios, Ericsson, ST-Ericsson, 3GPP TSG-RAN WG1 #70bis, San Diego, Calif., USA, 8^{th}-12^{th} Oct. 2012.

A homogeneous network is a network of base stations (also referred to as NodeB's, enhanced NodeB's, or eNBs) in a planned layout, providing communications services for a collection of user terminals (also referred to as user equipment nodes, UEs, and/or wireless terminals) in which all base stations may have similar transmit power levels, antenna patterns, receiver noise floors, and/or backhaul connectivity to the data network. Moreover, all base stations in a homogeneous network may offer unrestricted access to user terminals in the network, and each base station may serve roughly a same number of user terminals. Current cellular wireless communications systems in this category may include, for example, Global System for Mobile communication, GSM, WCDMA, High Speed Downlink Packet Access, HSDPA, LTE, Worldwide Interoperability for Microwave Access, WiMax, etc.

In a heterogeneous network, low power base stations (also referred to as low power nodes, LPNs, micro nodes, pico nodes, femto nodes, relay nodes, remote radio unit nodes, RRU nodes, small cells, RRUs, etc.) may be deployed along with or as an overlay to planned and/or regularly placed macro base stations. A macro base station, MBS, may thus provide service over a relatively large macro cell area and each LPN may provide service for a respective relatively small LPN cell area within the relatively large macro cell area. Power transmitted by an LPN (e.g. 2 Watts) may be relatively small compared to power transmitted by a macro base station (e.g. 40 Watts for a typical macro base station). An LPN may be deployed, for example, to reduce/eliminate a coverage hole(s) in the coverage provided by the macro base stations, and/or to off-load traffic from macro base stations (e.g., to increase capacity in a high traffic location, also referred to as a hot-spot). Due to the lower transmit power and smaller physical size, an LPN may offer greater flexibility for site acquisition.

In initial discussions among members of the 3^{rd}-Generation Partnership Project (3GPP) regarding the development of Release 12 specifications for LTE, one of the proposed items for study is the possibility of simultaneously serving a User Equipment (UE) from more than one eNB. In the disclosure that follows, this is called “dual connectivity.”

### SUMMARY

The object is to obviate at least some of the problems outlined above. In particular, it is an object to provide a Master eNB, MeNB and a Secondary eNB, SeNB, and respective methods performed thereby for modifying a radio resource of the SeNB with respect to a User Equipment, UE, currently being connected to the MeNB. These objects and others may be obtained by providing a MeNB and a SeNB and a respective method performed by the MeNB and the SeNB according to the independent claims attached below.

According to an aspect a method performed by a MeNB in a wireless communication system, the wireless communication system being adapted to provide for dual connectivity between a UE and the MeNB, and the UE and a SeNB, for modifying a radio resource configuration of the SeNB with respect to the UE currently being connected to the MeNB. The method comprises transmitting, to the SeNB, a request for radio resource modification with regards to an SeNB radio resource configuration between the SeNB and the UE, the request comprising a target MeNB radio resource configuration; and receiving, from the SeNB, the SeNB radio resource configuration with regards to the radio resource between the SeNB and the UE.

According to an aspect, a method performed by a SeNB for modifying a radio resource of the SeNB, with respect to a UE currently being connected to an MeNB, the SeNB being operable in a wireless communication system, the wireless communication system being adapted to provide for dual connectivity between the UE and the MeNB and the UE and the SeNB. The method comprises receiving, from the MeNB, a request for radio resource modification with regards to a radio resource between the SeNB and the UE, the request comprising a target MeNB radio resource configuration. The method further comprises determining an SeNB radio resource configuration between the SeNB and the UE based on the received target MeNB radio resource configuration; and transmitting, to the MeNB, the determined SeNB radio resource configuration.

According to an aspect, a MeNB in a wireless communication system, the wireless communication system being adapted to provide for dual connectivity between a UE and the MeNB, and the UE and a SeNB, the MeNB being configured for modifying a radio resource configuration of the SeNB with respect to the UE currently being connected to the MeNB. The MeNB is configured for transmitting, to the SeNB, a request for radio resource modification with regards to an SeNB radio resource configuration between the SeNB and the UE, the request comprising a target MeNB radio resource configuration; and receiving, from the SeNB, the SeNB radio resource configuration with regards to the radio resource between the SeNB and the UE.

According to an aspect, a SeNB for modifying a radio resource of the SeNB, with respect to a UE currently being connected to a MeNB, the SeNB being operable in a wireless communication system, the wireless communication system being adapted to provide for dual connectivity between the UE and the MeNB and the UE and the SeNB. The SeNB is configured for receiving, from the MeNB, a request for radio resource modification with regards to a radio resource between the SeNB and the UE, the request comprising a target MeNB radio resource configuration. The SeNB is further configured for determining an SeNB radio resource configuration between the SeNB and the UE based on the received target MeNB radio resource configuration; and transmitting, to the MeNB, the determined SeNB radio resource configuration.

The MeNB, the SeNB and the respective method performed thereby may have several possible advantages. The SeNB may be able to maximise the use of the UE's capabilities taking into account the MeNB configuration that would result from the dual connectivity setup/modification action, while ensuring that QoS requirements are fulfilled and UE capabilities are not exceeded.

### BRIEF DESCRIPTION OF DRAWINGS

Embodiments will now be described in more detail in relation to the accompanying drawings, in which:

FIG. 1 is a schematic/block diagram illustrating the overall E-UTRAN architecture.

FIG. 2 is a block diagram illustrating a functional split between E-UTRAN and the Evolved Packet Core (EPC).

FIG. 3 is a schematic diagram illustrating a user plane protocol stack.

FIG. 4 is a schematic diagram illustrating a control plane protocol stack.

FIG. 5 is a block diagram illustrating user plane and control plane data flows.

FIG. 6 is a schematic diagram illustrating a heterogeneous deployment with a higher-power macro node and a lower-power pico node according to some embodiments.

FIG. 7 is a schematic diagram illustrating an example heterogeneous deployment where the pico node corresponds to a cell of its own (a “pico cell”). The indices “p” and “m” indicate common signals/channels for the pico and macro cell respectively.

FIG. 8 is a schematic diagram illustrating an example heterogeneous deployment where the pico node does not correspond to a cell of its own.

FIG. 9 is a schematic diagram illustrating single-frequency network (SFN) operation with identical transmission from macro and pico nodes to a wireless terminal according to some embodiments.

FIG. 10 is a schematic diagram illustrating dual connectivity operation with the UE (wireless terminal) having multiple connections with both the master (macro) and secondary (pico) nodes according to some embodiments.

FIG. 11 is a block diagram illustrating a protocol architecture for multiple connectivity according to some embodiments.

FIG. 12 is a signal flow diagram illustrating a contention-based random access procedure in LTE.

FIG. 13 is a schematic diagram illustrating control plane termination for dual connectivity, according to some embodiments.

FIG. 14 is a signal flow diagram illustrating an example procedure for parameter negotiation between a master eNB and a secondary eNB.

FIG. 15 illustrates an example of dual connectivity operation with the UE having multiple connections with both the MeNB and SeNB.

FIG. 16 illustrates three options for splitting the U-Plane data.

FIG. 17 illustrates an example of user plane protocol termination for bearer split option 1.

FIG. 18 illustrates an example of a user plane protocol architecture for bearer split option 3.

FIG. 19 illustrates an example of combined user plane architecture for 1A and 3C.

FIG. 20 illustrates an example of Radio Interface C-plane architecture for dual connectivity.

FIG. 21 illustrates an example of SRB only transported via MeNB.

FIG. 22 illustrates an example of an SeNB addition/modification signalling sequence.

FIG. 23a is a flowchart of a method performed by a MeNB for modifying a radio resource of a SeNB, with respect to a currently being connected to the MeNB, according to an exemplifying embodiment.

FIG. 23b is a flowchart of a method performed by a MeNB for modifying a radio resource of a SeNB, with respect to a UE currently being connected to the MeNB, according to yet an exemplifying embodiment.

FIG. 23c is a flowchart of a method performed by a MeNB for modifying a radio resource of a SeNB, with respect to a UE currently being connected to the MeNB, according to still an exemplifying embodiment.

FIG. 24a is a flowchart of a method performed by a SeNB for modifying a radio resource of the SeNB with respect to a UE currently being connected to a MeNB, according to an exemplifying embodiment.

FIG. 24b is a flowchart of a method performed by a SeNB for modifying a radio resource of the SeNB with respect to a UE currently being connected to a MeNB, according to yet an exemplifying embodiment.

FIG. 24c is a flowchart of a method performed by a SeNB for modifying a radio resource of the SeNB with respect to a UE currently being connected to a MeNB, according to still an exemplifying embodiment.

FIG. 25 is a block diagram of a MeNB configured for modifying a radio resource of a SeNB, with respect to a currently being connected to the MeNB, according to an exemplifying embodiment.

FIG. 26 is a block diagram of a MeNB configured for modifying a radio resource of a SeNB, with respect to a currently being connected to the MeNB, according to yet an exemplifying embodiment.

FIG. 27 is a block diagram of a SeNB configured for modifying a radio resource of the SeNB with respect to a UE currently being connected to a MeNB, according to an exemplifying embodiment.

FIG. 28 is a block diagram of a SeNB configured for modifying a radio resource of the SeNB with respect to a UE currently being connected to a MeNB, according to yet an exemplifying embodiment.

FIG. 29 is a block diagram of an arrangement in a MeNB configured for modifying a radio resource of a SeNB, with respect to a currently being connected to the MeNB, according to an exemplifying embodiment.

FIG. 30 is a block diagram of an arrangement in a SeNB configured for modifying a radio resource of the SeNB with respect to a UE currently being connected to a MeNB, according to an exemplifying embodiment.

FIG. 31 is a block diagram of a terminal according to an embodiment.

FIG. 32 is a block diagram of a network node according to an embodiment.

### DETAILED DESCRIPTION

Briefly described a Master evolved Node B, MeNB, in a wireless communication system, the wireless communication system being adapted to provide for dual connectivity between a UE and a MeNB and the UE and a SeNB; and a method performed by the MeNB for modifying a radio resource of a Secondary eNB, SeNB, with respect to the UE currently being connected to the MeNB are provided. Further a SeNB and a method performed by the SeNB for modifying a radio resource of the SeNB, with respect to a UE currently being connected to MeNB are provided, wherein the SeNB being operable in a wireless communication system, the wireless communication system being adapted to provide for dual connectivity between the UE and the MeNB and the UE and the SeNB. Modification of a radio resource of the SeNB may comprise modifying an existing radio resource or adding a new radio resource for the UE.

In this disclosure, the non-limiting terms MeNB and SeNB are used. They refer to any type of network node that serves wireless devices and/or is connected to other network node(s) or network element(s) or any radio node from where the wireless device receives signal(s). Examples of network nodes are Node B, Base Station, BS, Multi-Standard Radio, MSR, node such as MSR BS, eNode B, eNB, network controller, Radio Network Controller, RNC, Base Station Controller, BSC, relay, donor node controlling relay, Base Transceiver Station, BTS, Access Point, AP, transmission points, transmission nodes, Remote Radio Unit, RRU, Remote Radio Head, RRH, nodes in Distributed Antenna System, DAS.

Further in this disclosure, the non-limiting term UE is used. It refers to any type of wireless device that communicates with a radio network node in a cellular or mobile communication system. Examples of a UE are a mobile station, mobile telephone, target device, Device to Device, D2D, machine type UE or UE capable of Machine to Machine, M2M, communication, Personal Digital Assistant, PDA, iPAD, Tablet, mobile terminals, smart phone, Laptop Embedded Equipped, LEE, Laptop Mounted Equipment, LME, USB dongles, vehicles comprising means for communicating with e.g. MeNBs and SeNBs etc.

Particular embodiments will now be described more fully hereinafter with reference to the accompanying drawings; however, other embodiments may include many different forms and should not be construed as limited to the examples set forth herein. Embodiments of the disclosure need not be mutually exclusive, and components described with respect to one embodiment may be used in another embodiment(s).

For purposes of illustration and explanation only, particular embodiments are described in the context of operating in a RAN that communicates over radio communication channels with UEs. It will be understood, however, any suitable type of communication network could be used. As used herein, a wireless terminal or UE may include any device that receives data from a communication network, and may include, but is not limited to, a mobile telephone (“cellular” telephone), laptop/portable computer, pocket computer, hand-held computer, desktop computer, a machine to machine (M2M) or MTC type device, a sensor with a wireless communication interface, etc.

In some embodiments of a RAN, several base stations may be connected (e.g. by landlines or radio channels) to a radio network controller, RNC. A radio network controller, also sometimes termed a base station controller, BSC, may supervise and coordinate various activities of the plural base stations connected thereto. A radio network controller may be connected to one or more core networks. According to some other embodiments of a RAN, base stations may be connected to one or more core networks without a separate RNC(s) there between, for example, with functionality of an RNC implemented at base stations and/or core networks.

The Universal Mobile Telecommunications System, UMTS, is a third generation mobile communication system, which evolved from GSM, and is intended to provide improved mobile communication services based on WCDMA technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for UEs.

The Third Generation Partnership Project, 3GPP, has undertaken to further evolve the UTRAN and GSM based radio access network technologies. In this regard, specifications for the Evolved Universal Terrestrial Radio Access Network, E-UTRAN, are ongoing within 3GPP. The E-UTRAN comprises the LTE and System Architecture Evolution, SAE.

Note that although certain terminology from 3GPP LTE is used in some example embodiments, this should not be seen as limiting. Other wireless systems, such as WCDMA, HSPA, WiMax, Ultra Mobile Broadband, UMB, HSDPA, GSM etc. may be used in other embodiments.

Also note that terminology such as base station (also referred to as NodeB, eNodeB, or Evolved Node B) and wireless terminal (also referred to as User Equipment node or UE) should be considering non-limiting and does not imply a certain hierarchical relation between the two. In general, a base station (e.g. a “NodeB” or “eNodeB”) and a wireless terminal (e.g. a “UE”) may be considered as examples of respective different communications devices that communicate with each other over a wireless radio channel. While embodiments discussed herein may focus on wireless transmissions in a downlink from a NodeB to a UE, embodiments of the disclosed concepts may also be applied, for example, in an uplink. Furthermore, although the description below focuses, for purposes of illustration, on example embodiments in which described solutions are applied in heterogeneous networks that include a mix of relatively higher-power (e.g. “macro”) base stations and relatively lower-power node (e.g. “pico”) base stations, the described techniques may be applied in any suitable type of network, including both homogeneous and heterogeneous configurations. Thus, the base stations involved in the described configurations may be similar or identical to one another, or may differ in terms of transmission power, number of transmitter-receiver antennas, processing power, receiver and transmitter characteristics, and/or any other functional or physical capability.

Embodiments herein relate to a method performed by an MeNB in a wireless communication system, the wireless communication system being adapted to provide for dual connectivity between a UE and the MeNB, and the UE and a SeNB, for modifying a radio resource configuration of the SeNB with respect to the UE currently being connected to the MeNB. By modifying means changing an existing radio resource configuration or adding a Radio Access Bearer, RAB, between the SeNB and the UE.

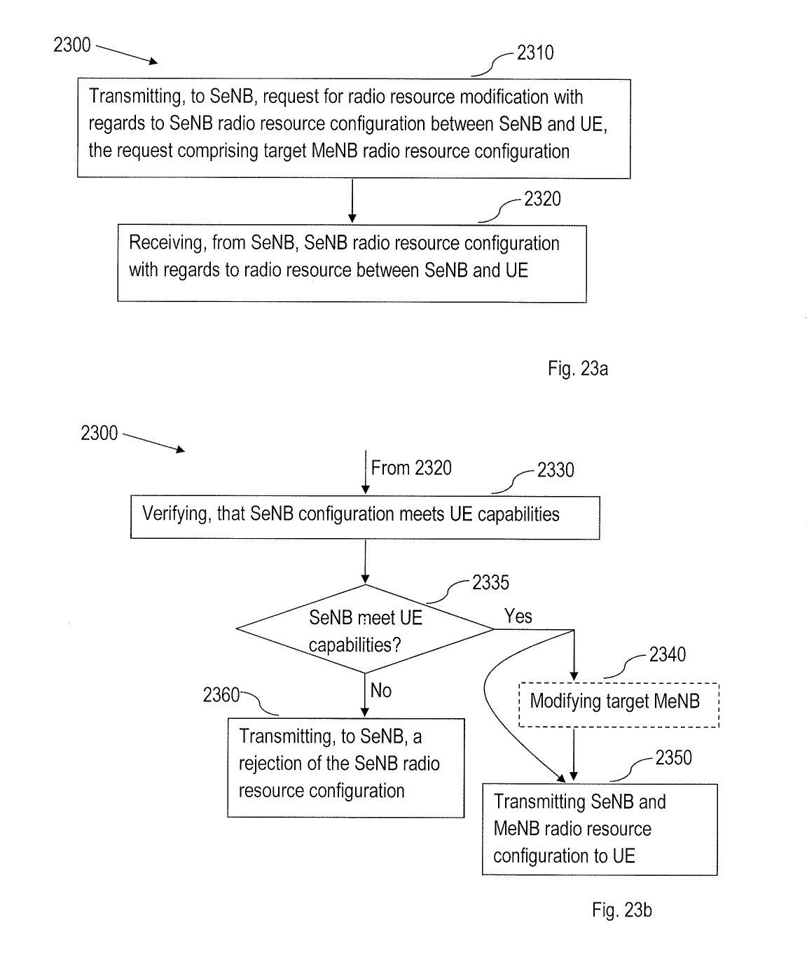

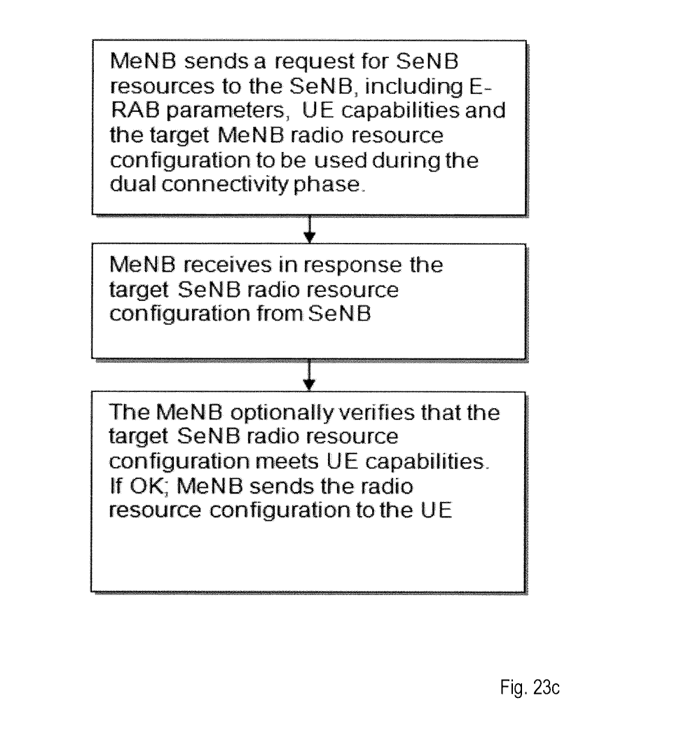

Embodiments of such a method will now be described with reference to FIGS. 23a-23c, which are flowcharts of embodiments of such a method.

FIG. 23a illustrates the method comprising transmitting 2310, to the SeNB, a request for radio resource modification with regards to an SeNB radio resource configuration between the SeNB and the UE, the request comprising a target MeNB radio resource configuration; and receiving 2320, from the SeNB, the SeNB radio resource configuration with regards to the radio resource between the SeNB and the UE.

When the MeNB determines that e.g. a new RAB is to be established between the SeNB and the UE or that an existing bearer RAB between the SeNB and the UE should be modified, the MeNB transmits the request for radio resource configuration modification. Since both the MeNB and the SeNB will be associated with the UE, the MeNB includes a target MeNB radio resource configuration in the request. The MeNB is currently employing a current radio resource configuration with regard to the UE and thus determines a target MeNB radio resource configuration with regard to the UE. The target MeNB radio resource configuration may be determined by the MeNB and it reflects the radio resource configuration that the MeNB intends to apply after the radio resource modification with regards to the SeNB radio resource configuration between the SeNB and the UE has been performed. This enables the SeNB to configure the radio resource configuration between the SeNB and the UE taking the target MeNB radio resource configuration into account as will be explained in more detail below.

Once the SeNB has determined the radio resource configuration between the SeNB and the UE, the SeNB transmits the determined radio resource configuration between the SeNB and the UE back to the MeNB. The MeNB receives the SeNB radio resource configuration with regards to the radio resource between the SeNB and the UE from the SeNB. In this manner, the MeNB and the SeNB may together provide coverage, capacity and services to the UE being served by both the MeNB and the SeNB.

The method performed by the MeNB may have several possible advantages. The SeNB may be able to maximise the use of the UE's capabilities taking into account the MeNB configuration that would result from the dual connectivity setup/modification action, while ensuring that QoS requirements are fulfilled and UE capabilities are not exceeded.

The request for radio resource modification may further comprise Radio Access Bearer, RAB, parameters, and UE capabilities when modifying the radio resource of the SeNB comprises adding a RAB between the SeNB and the UE.

The MeNB may also include RAB parameters and UE capabilities into the request for radio resource modification with regards to the SeNB radio resource configuration between the SeNB and the UE.

In order for the SeNB to be able to determine a radio resource configuration that is suitable for the UE, the MeNB may also include RAB parameters and UE capabilities in the request in addition to the target MeNB radio resource configuration.

The RAB parameters provide the SeNB with information such as Quality of Service, QoS. Different RABs may be established for different services and different services may require different QoS. Thus, the RAB parameters informs the SeNB about requirements for the RAB, both if it is a new RAB that is to be established or an existing RAB that is to be modified.

UE capabilities may also be of interest to the SeNB since the radio resource configuration that the SeNB is to modify, or determine, should meet the UE capabilities. Different UEs may have different capabilities and since the radio resource configuration is between the SeNB and the UE, the capabilities of the UE may be taken into account when determining the radio resource configuration is between the SeNB and the UE.

The MeNB and the SeNB may thus need to consider UE device capabilities/limitations when selecting their respective target radio configurations. There may be many different UE limitations that require MeNB and SeNB to have aligned radio resource configurations with respect to the UE capabilities. For example:
MiMO layer limitation. The UE may be capable of supporting MIMO (Multiple Input, Multiple Output, refers to the use of multiple data streams to the UE via different MIMO layers), but the total number of layers may be limited. This means that SeNB may be dependent upon the number of MIMO layers that MeNB will target.
band combination limitation. The UE may support multiple frequency carriers simultaneously (carrier aggregation), but the support may be restricted to certain band combinations. This means that SeNB may be dependent upon the bands that MeNB will target.
bitrate limitation. The UE may be restricted in the aggregate bit rate it can support over all bearers. This means that SeNB may be dependent upon the configurations that MeNB will target.
random access transmission limitation. The UE may be restricted in that it can only transmit random access to one eNB at the time, which may require that SeNB and MeNB could align the announced random access opportunities.
time/frequency resource limitation. For example, a UE may be restricted in that it can only transmit to and/or receive from one eNB at the time. In such cases, the t/f resources may need to be coordinated between MeNB and SeNB.
measurement limitations. For example, there may be limitations to how many measurement processes (e.g. to measure different channel state information reference signals, CSI-RS, or measure at resources which serving cell has left intentionally blank, CSI-IM, interference measurement) the UE can handle. This means that MeNB and SeNB may need to coordinate.

The method may still further comprise verifying 2330 that the SeNB radio resource configuration meets the UE capabilities, and transmitting 2350 the SeNB radio resource configuration and the target MeNB radio resource configuration to the UE when the SeNB radio resource configuration meets the UE capabilities.

Before the MeNB accepts the SeNB radio resource configuration with respect to the UE, the MeNB may ensure that the radio resource configuration meets the UP capabilities. It may be that the UE capabilities were not included in the request for radio resource modification with regards to the SeNB radio resource configuration between the SeNB and the UE. It may additionally, or alternatively, be that the SeNB failed to determine, or configure, the radio resource configuration between the SeNB and the UE properly.

Since the MeNB is responsible for the UE, being the MeNB, the MeNB verifies that the SeNB radio resource configuration meets the UE capabilities. Once the MeNB has verified this, the MeNB may transmit the SeNB radio resource configuration and the target MeNB radio resource configuration to the UE. In this manner, the UE may rely on that the SeNB radio resource configuration and the target MeNB radio resource configuration that it receives are suitable for use and may thus start using them.

Still further, the method may comprise modifying 2340 the target MeNB radio resource configuration and transmitting the SeNB radio resource configuration and the modified target MeNB configuration to the UE.

It may happen that the SeNB was not able to configure the radio resource configuration between the SeNB and the UE to be optimal to use in cooperation with the target MeNB radio resource configuration.

In such a case, the MeNB may analyse the received SeNB radio resource configuration and then based on it, modify its own target MeNB radio resource configuration to better cooperate, or match, the received radio resource configuration between the SeNB and the UE.

According to an embodiment, the method further comprises verifying 2330 that the SeNB configuration meets the UE capabilities, and transmitting 2360 a rejection of the SeNB radio resource configuration to the SeNB, when the SeNB configuration does not meet the UE capabilities.

As described above, the MeNB may verify that the SeNB configuration meets the UE capabilities. If the SeNB configuration does not meet the UE capabilities, the SeNB radio resource configuration may not be suitable to use between the UE and the SeNB. In order to prevent that a non-suitable SeNB radio resource configuration is established, or used, the MeNB may reject the SeNB radio resource configuration. The MeNB then sends a rejection to the SeNB.

The MeNB may thereafter transmit a new request to the SeNB for radio resource modification with regards to the SeNB radio resource configuration between the SeNB and the UE. The MeNB may before determine a new target MeNB radio resource configuration, or updating the previous one, and include the new, or updated, new target MeNB radio resource configuration in the new request to the SeNB for radio resource modification with regards to the SeNB radio resource configuration between the SeNB and the UE.

The rejection may comprise an updated target MeNB radio resource configuration.

Instead of first sending a rejection and then a new request, the MeNB may include the updated target MeNB radio resource configuration. In this manner the signalling between the MeNB and the SeNB may be reduced and the rejection may serve two purposes, both as a rejection and as a request for a new SeNB for radio resource modification with regards to the SeNB radio resource configuration between the SeNB and the UE.

According to an embodiment, transmitting the target MeNB radio resource configuration comprised in the request for radio resource modification, to the SeNB, is performed by means of Radio Resource Configuration, RRC, information element AS-Config.

There are different ways to transmit the target MeNB radio resource configuration comprised in the request for radio resource modification to the SeNB. One example is the RRC Information Element (IE) AS-Config. The AS-Config IE is used during legacy handover and contains information of the radio resource configuration in the source eNB, which can be utilised by the target eNB to determine the need to change the radio resource configuration during the handover preparation phase.

Still further, the method may comprise incrementing a first counter for the SeNB when the MeNB successfully verifies that the SeNB configuration meets the UE capabilities and/or incrementing a second counter whenever the SeNB configuration violates the UE capabilities.

The MeNB may gather statistics about the negotiation procedure, for example by aggregating events in one or more counters. For example, the MeNB may aggregate events in at least one counter per SeNB. These counters may be used in the MeNB for future radio resource configurations and/or in reports to a management node. Example of events include:
That the SeNB has utilised a freed resource that is free in the target MeNB configuration, but is used in the current MeNB configuration.
That the SeNB has proposed a target configuration that violated the UE capability.
That the SeNB has proposed a target configuration that violated the UE capability N times, for different N.

Embodiments herein also relate to a method performed by an SeNB for modifying a radio resource of the SeNB, with respect to a UE currently being connected to an MeNB, the SeNB being operable in a wireless communication system, the wireless communication system being adapted to provide for dual connectivity between the UE and the MeNB and the UE and the SeNB.

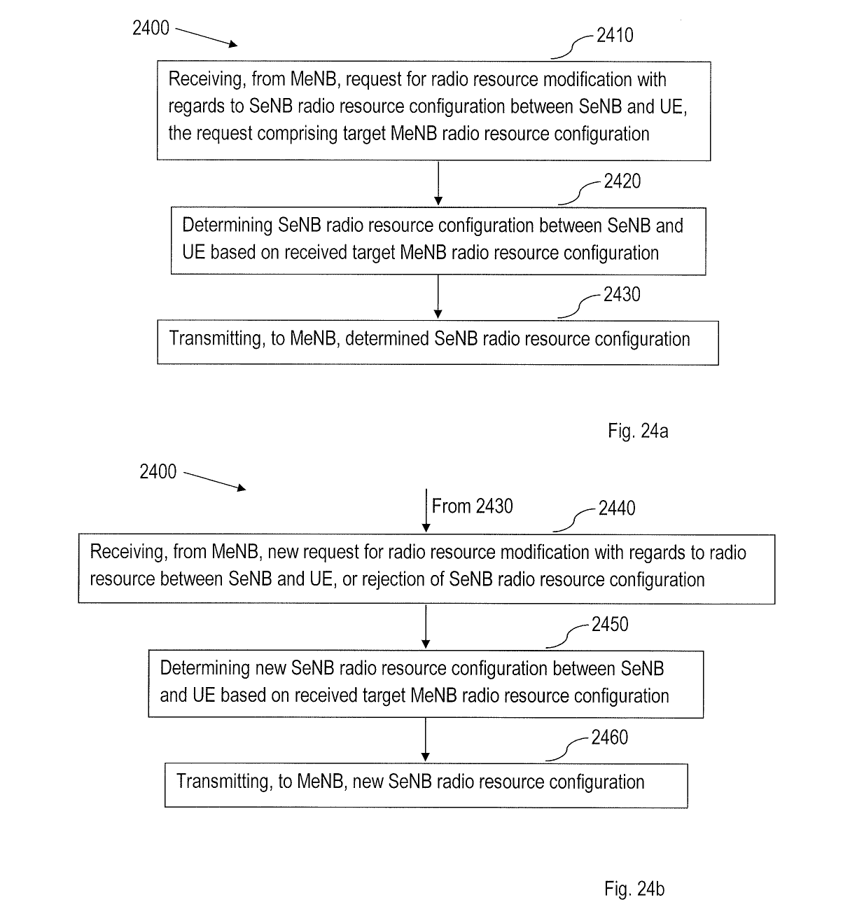

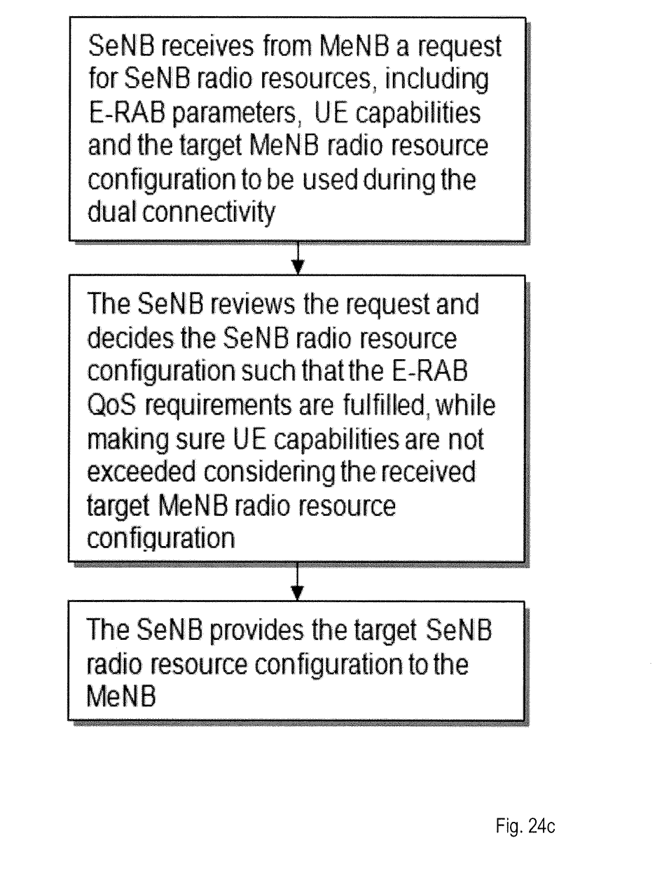

Embodiments of such a method will now be described with reference to FIGS. 24a-24c, which are flowcharts of embodiments of such a method.

FIG. 24a illustrates the method comprising receiving 2410, from the MeNB, a request for radio resource modification with regards to a radio resource between the SeNB and the UE, the request comprising a target MeNB radio resource configuration. The method further comprises determining 2420 an SeNB radio resource configuration between the SeNB and the UE based on the received target MeNB radio resource configuration; and transmitting 2430, to the MeNB, the determined SeNB radio resource configuration.

When the MeNB has determined that the radio resource configuration between the SeNB and the UE should be modified (updated or new RAB created), the MeNB send the request for radio resource modification with regards to the radio resource between the SeNB and the UE. As described above, the request comprises the target MeNB radio resource configuration, wherein the SeNB may determine the SeNB radio resource configuration between the SeNB and the UE based on the received target MeNB radio resource configuration. Since the MeNB radio resource configuration and the SeNB radio resource configuration are supposed to coexist and cooperate e.g. with providing coverage and service to the UE, the SeNB bases its radio resource configuration based on the target MeNB radio resource configuration.

The SeNB then transmits the determined SeNB radio resource configuration to the MeNB.

The method performed by the SeNB has the same possible advantages as the method performed by the MeNB. The SeNB may be able to maximise the use of the UE's capabilities taking into account the MeNB configuration that would result from the dual connectivity setup/modification action, while ensuring that QoS requirements are fulfilled and UE capabilities are not exceeded.

The request for radio resource modification may further comprise RAB parameters and UE capabilities, when modifying the radio resource of the SeNB with respect to the UE comprises adding a RAB between the SeNB and the UE.

As explained above, in order for the SeNB to be able to determine a radio resource configuration that is suitable for the UE, the SeNB may also take the RAB parameters and UE capabilities, in addition to the target MeNB radio resource configuration, into consideration when determining the SeNB radio resource configuration.

The RAB parameters provide the SeNB with information such as Quality of Service, QoS. Different RABs may be established for different services and different services may require different QoS. Thus, the RAB parameters informs the SeNB about requirements for the RAB, both if it is a new RAB that is to be established or an existing RAB that is to be modified.

UE capabilities may also be of interest to the SeNB since the radio resource configuration that the SeNB is to modify, or determine, should meet the UE capabilities. Different UEs may have different capabilities and since the radio resource configuration is between the SeNB and the UE, the capabilities of the UE may be taken into account when determining the radio resource configuration is between the SeNB and the UE.

If a new RAB is to be added, then the RAB is determined based on the target MeNB radio resource configuration, the RAB parameters, and the UE capabilities.

Determining 2420 the SeNB radio resource configuration with respect to the UE may further be based on the received UE capabilities and RAB parameters.

According to an embodiment, the method 2400 further comprises receiving 2440, from the MeNB, a new request for radio resource modification with regards to the radio resource between the SeNB and the UE, or a rejection of the SeNB radio resource configuration; determining 2450 a new SeNB radio resource configuration between the SeNB and the UE based on the received target MeNB radio resource configuration; and transmitting 2460, to the MeNB, the new SeNB radio resource configuration.

It might be, as described above, that the MeNB does not accept the determined SeNB radio resource configuration. Since the MeNB is responsible for the UE, the MeNB may then reject the determined SeNB radio resource configuration. The SeNB is informed by this by receiving a rejection of the SeNB radio resource configuration and/or by receiving the new request for radio resource modification with regards to the radio resource between the SeNB and the UE.

The SeNB then proceeds with determining the new SeNB radio resource configuration between the SeNB and the UE based on the received target MeNB radio resource configuration; and transmitting, to the MeNB, the new SeNB radio resource configuration.

The new request for radio resource modification may further comprise an updated target MeNB radio resource configuration, wherein determining 2450 the new SeNB radio resource configuration is based on the received updated target MeNB radio resource configuration.

If the new request for radio resource modification comprises the updated target MeNB radio resource configuration, the SeNB should determine the SeNB radio resource configuration based on the updated target MeNB radio resource configuration since the MeNB and SeNB may serve the UE together as described above.

In the manner described above, improved selection of SeNB radio resource configuration is enabled. The SeNB receives from the MeNB the target MeNB radio configuration that the MeNB intends to apply, and the UE capabilities (if not previously signalled). Thereby, the SeNB is able to select a suitable SeNB radio resource configuration in consideration of the UE capabilities and also possible freed resources from the MeNB radio resource configuration. Finally, the SeNB may signal its target SeNB radio resource configuration to the MeNB.

From the MeNB perspective, the MeNB may signal its intended target MeNB radio resource configuration and the UE capabilities (if not previously signalled) to the SeNB. In response, the MeNB may receive the target SeNB radio resource configuration from the SeNB. Optionally, the MeNB may verify that the proposed target SeNB complies with the UE capabilities. Once the MeNB and SeNB radio resource configurations have been determined, the MeNB sends the MeNB and SeNB radio resource configurations to the UE.

In some embodiments, the MeNB may reject the target SeNB radio resource configuration, for example, if the proposed target SeNB radio resource configuration does not meet the UE capabilities in consideration of the target MeNB radio resource configuration or if the MeNB has reconsidered/updated the target MeNB radio resource configuration. The MeNB may send a rejection to the SeNB. In some embodiments, the rejection could possibly include a target MeNB radio resource configuration (e.g., the updated target) or a reason for the rejection (e.g., the proposed target SeNB radio resource configuration does not meet the UE capabilities in consideration of the target MeNB radio resource configuration). Thereby, the MeNB may request a target SeNB radio resource configuration by either a request message or a reject message.

FIGS. 23a-24c illustrate example of steps that may be taken to configure the MeNB and/or SeNB. FIG. 23c describes example steps from the SeNB perspective with X2 signalling. FIG. 24c describes example steps from the MeNB perspective, with signalling over X2 and RRC.

With respect to the information exchange between the MeNB and SeNB, the steps for selecting MeNB and SeNB radio resource configurations may include:
1. MeNB decides either to add an SCG or to modify existing SCG configuration, e.g. based on RRM measurement from the UE.
2. MeNB requests SeNB to allocate radio resources with a “SeNB addition/modification request” message. The message may contain the following information elements: (a) E-RAB parameters, (b) UE capabilities, (c) The target radio resource configuration the MeNB wants to apply if the SeNB is able to allocate or modify SCG resources as requested by the MeNB. This could be signalled as part of inter-node RRC information element AS-Config, similarly as during normal handover. The reason for using the target MeNB radio resource configuration here as opposed to the current MeNB radio resource configuration is that the MeNB may want to change its configuration and the SeNB should know the target configuration in order to select its own configuration properly.
3. The SeNB reviews the request and decides the SeNB radio resource configuration such that the E-RAB QoS requirements are fulfilled, while making sure UE capabilities are not exceeded considering the intended MeNB configuration.
4. The SeNB provides the SeNB radio resource configuration to the MeNB in the “SeNB addition/modification command” message. For the SeNB triggered procedure, this message starts the procedure. The message may contain the following information elements: (a) The radio resource configuration the SeNB wants to apply during the dual connectivity phase. This could be signalled as part of inter-node RRC information element AS-Config, similarly as during normal handover.
5. The MeNB endorses the SeNB configuration, adds possible changes to the MeNB radio resource configuration, compiles the final RRCconnectionReconfiguration message and sends it to the UE. The UE starts to apply the new configuration.

Embodiments herein also relate to a MeNB in a wireless communication system, the wireless communication system being adapted to provide for dual connectivity between a UE and the MeNB, and the UE and a SeNB, the MeNB being configured for modifying a radio resource configuration of the SeNB with respect to the UE currently being connected to the MeNB. By modifying means changing an existing radio resource configuration or adding a Radio Access Bearer, RAB, between the SeNB and the UE.

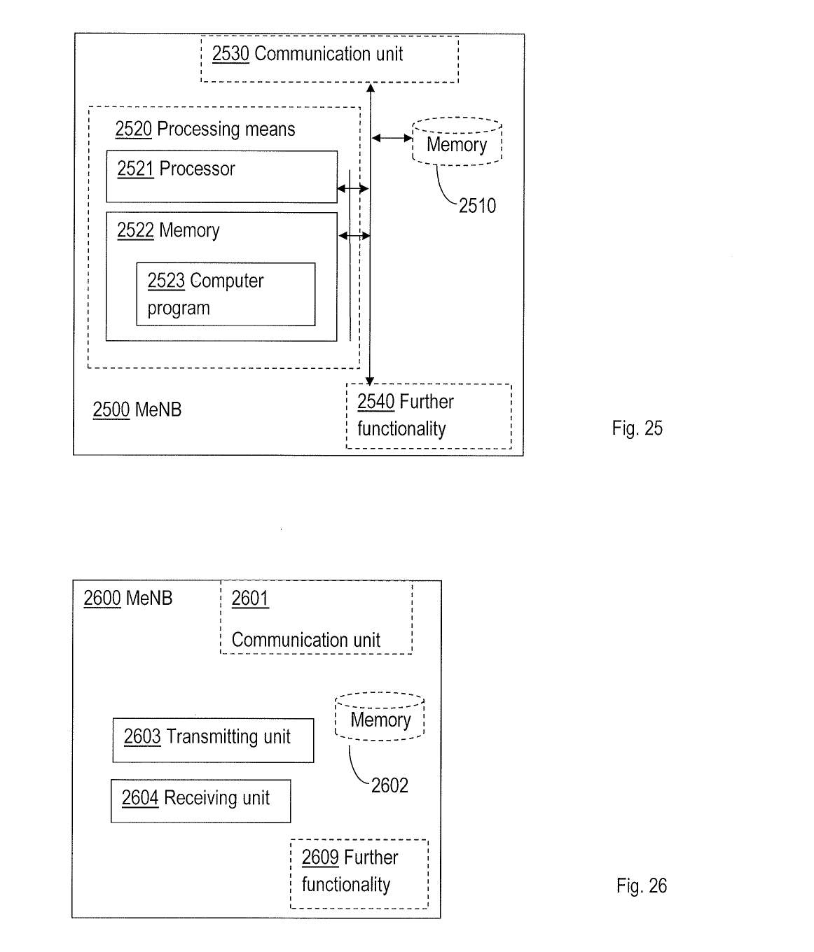

Embodiments of such a MeNB will now be described with reference to FIGS. 25 and 26, which are block diagrams of embodiments of such a MeNB. The MeNB has the same technical features, objects and advantages as the method performed by the MeNB. The MeNB will only be described in brief in order to avoid unnecessary repetition.

FIGS. 25 and 26 illustrate the MeNB 2500, 2600 being configured for transmitting, to the SeNB, a request for radio resource modification with regards to an SeNB radio resource configuration between the SeNB and the UE, the request comprising a target MeNB radio resource configuration; and receiving, from the SeNB, the SeNB radio resource configuration with regards to the radio resource between the SeNB and the UE.

The MeNB 2500, 2600 may be realised or implemented in various different ways. A first exemplifying implementation is illustrated in FIG. 25. FIG. 25 illustrate the MeNB 2500 comprising a processor 2521 and memory 2522, the memory comprising instructions, e.g. by means of a computer program 2523, which when executed by the processor 2521 causes the MeNB 2500 to transmit, to the SeNB, a request for radio resource modification with regards to an SeNB radio resource configuration between the SeNB and the UE, the request comprising a target MeNB radio resource configuration; and to receive, from the SeNB, the SeNB radio resource configuration with regards to the radio resource between the SeNB and the UE.

FIG. 25 also illustrates the MeNB 2500 comprising a memory 2510. It shall be pointed out that FIG. 25 is merely an exemplifying illustration and memory 2510 may be optional, be a part of the memory 2522 or be a further memory of the MeNB. The memory may for example comprise information relating to the MeNB 2500, to statistics of operation of the MeNB 2500, just to give a couple of illustrating examples. FIG. 25 further illustrates the MeNB 2500 comprising processing means 2520, which comprises the memory 2522 and the processor 2521. Still further, FIG. 25 illustrates the MeNB 2500 comprising a communication unit 2530. The communication unit 2530 may comprise an interface through which the MeNB 2500 communicates with other nodes or entities of the communication network as well as wireless devices of the communication network. FIG. 25 also illustrates the MeNB 2500 comprising further functionality 2540. The further functionality 2540 may comprise hardware of software necessary for the MeNB 2500 to perform different tasks that are not disclosed herein. Merely as an illustrative example, the further functionality may comprise a scheduler for scheduling transmissions from the MeNB 2500 and/or for transmissions from wireless devices with which the MeNB 2500 communicates with.

An alternative exemplifying implementation of the MeNB is illustrated in FIG. 26. FIG. 26 illustrates the MeNB 2600 comprising a transmitting unit 2603 for transmitting, to the SeNB, a request for radio resource modification with regards to an SeNB radio resource configuration between the SeNB and the UE, the request comprising a target MeNB radio resource configuration; and a receiving unit 2604 for receiving, from the SeNB, the SeNB radio resource configuration with regards to the radio resource between the SeNB and the UE.

In FIG. 26, the MeNB 2600 is also illustrated comprising a communication unit 2601. Through this unit, the MeNB 2600 is adapted to communicate with other nodes and/or entities in the wireless communication network. The communication unit 2601 may comprise more than one receiving arrangement. For example, the communication unit 2601 may be connected to both a wire and an antenna, by means of which the MeNB 2600 is enabled to communicate with other nodes and/or entities in the wireless communication network. Similarly, the communication unit 2601 may comprise more than one transmitting arrangement, which in turn is connected to both a wire and an antenna, by means of which the MeNB 2600 is enabled to communicate with other nodes and/or entities in the wireless communication network. The MeNB 2600 further comprises a memory 2602 for storing data. Further, the MeNB 2600 may comprise a control or processing unit (not shown) which in turn is connected to the different units 2603-2604. It shall be pointed out that this is merely an illustrative example and the MeNB 2600 may comprise more, less or other units or modules which execute the functions of the MeNB 2600 in the same manner as the units illustrated in FIG. 26.

It should be noted that FIG. 26 merely illustrates various functional units in the MeNB 2600 in a logical sense. The functions in practice may be implemented using any suitable software and hardware means/circuits etc. Thus, the embodiments are generally not limited to the shown structures of the MeNB 2600 and the functional units. Hence, the previously described exemplary embodiments may be realised in many ways. For example, one embodiment includes a computer-readable medium having instructions stored thereon that are executable by the control or processing unit for executing the method steps in the MeNB 2600. The instructions executable by the computing system and stored on the computer-readable medium perform the method steps of the MeNB 2600 as set forth in the claims.

The MeNB has the same possible advantages as the method performed by the MeNB. The SeNB may be able to maximise the use of the UE's capabilities taking into account the MeNB configuration that would result from the dual connectivity setup/modification action, while ensuring that QoS requirements are fulfilled and UE capabilities are not exceeded.

According to an embodiment, the request for radio resource modification further comprises RAB parameters and UE capabilities when the MeNB is configured for modifying the radio resource of the SeNB by adding a RAB between the SeNB and the UE.

According to yet an embodiment, the MeNB further is configured for verifying that the SeNB radio resource configuration meets the UE capabilities, and for transmitting the SeNB radio resource configuration and the target MeNB radio resource configuration to the UE when the SeNB radio resource configuration meets the UE capabilities.

According to still an embodiment, the MeNB further is configured for modifying the target MeNB radio resource configuration and for transmitting the SeNB radio resource configuration and the modified target MeNB configuration to the UE.

According to another embodiment, the MeNB further is configured for verifying that the SeNB configuration meets the UE capabilities, and for transmitting a rejection of the SeNB configuration, when the SeNB configuration does not meet the UE capabilities.

According to an embodiment, the rejection comprises an updated target MeNB radio resource configuration.

According to yet an embodiment, the MeNB is configured for transmitting the target MeNB radio resource configuration comprised in the request for radio resource modification, to the SeNB, by means of Radio Resource Configuration, RRC, information element AS-Config.

According to still an embodiment, the MeNB is configured for incrementing a first counter for the SeNB when the MeNB successfully verifies that the SeNB configuration meets the UE capabilities and/or for incrementing a second counter whenever the SeNB configuration violates the UE capabilities.

Embodiments herein also relate to a SeNB for modifying a radio resource of the SeNB, with respect to a UE currently being connected to a MeNB, the SeNB being operable in a wireless communication system, the wireless communication system being adapted to provide for dual connectivity between the UE and the MeNB and the UE and the SeNB. By modifying means changing an existing radio resource configuration or adding a Radio Access Bearer, RAB, between the SeNB and the UE.

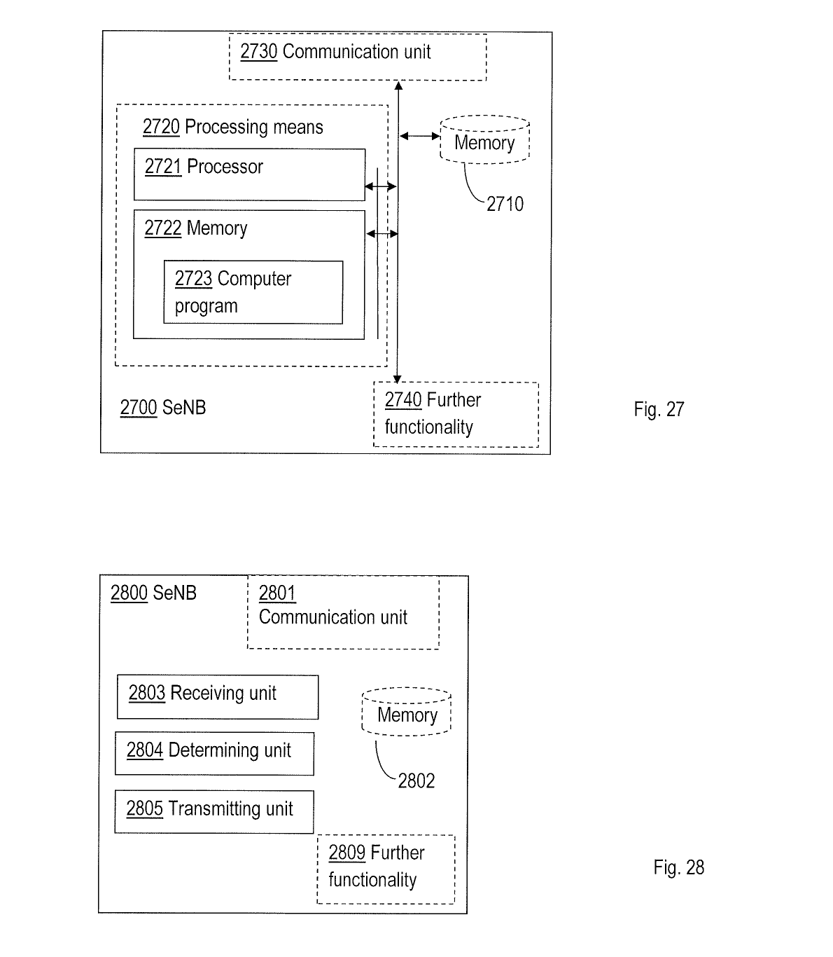

Embodiments of such a SeNB will now be described with reference to FIGS. 27 and 28, which are block diagrams of embodiments of such an SeNB. The SeNB has the same technical features, objects and advantages as the method performed by the SeNB. The SeNB will only be described in brief in order to avoid unnecessary repetition.

FIGS. 27 and 28 illustrate the SeNB 2700, 2800 being configured for receiving, from the MeNB, a request for radio resource modification with regards to a radio resource between the SeNB and the UE, the request comprising a target MeNB radio resource configuration. The SeNB is further configured for determining an SeNB radio resource configuration between the SeNB and the UE based on the received target MeNB radio resource configuration; and transmitting, to the MeNB, the determined SeNB radio resource configuration.

The SeNB 2700, 2800 may be realised or implemented in various different ways. A first exemplifying implementation is illustrated in FIG. 27. FIG. 27 illustrate the SeNB 2700 comprising a processor 2721 and memory 2722, the memory comprising instructions, e.g. by means of a computer program 2723, which when executed by the processor 2721 causes the SeNB 2700 to receive, from the MeNB, a request for radio resource modification with regards to a radio resource between the SeNB and the UE, the request comprising a target MeNB radio resource configuration; to determine an SeNB radio resource configuration between the SeNB and the UE based on the received target MeNB radio resource configuration; and to transmit, to the MeNB, the determined SeNB radio resource configuration.

FIG. 27 also illustrates the SeNB 2700 comprising a memory 2710. It shall be pointed out that FIG. 27 is merely an exemplifying illustration and memory 2710 may be optional, be a part of the memory 2722 or be a further memory of the SeNB. The memory may for example comprise information relating to the SeNB 2700, to statistics of operation of the SeNB 2700, just to give a couple of illustrating examples. FIG. 27 further illustrates the SeNB 2700 comprising processing means 2720, which comprises the memory 2722 and the processor 2721. Still further, FIG. 27 illustrates the SeNB 2700 comprising a communication unit 2730. The communication unit 2730 may comprise an interface through which the SeNB 2700 communicates with other nodes or entities of the communication network as well as wireless devices of the communication network. FIG. 27 also illustrates the SeNB 2700 comprising further functionality 2740. The further functionality 2740 may comprise hardware of software necessary for the SeNB 2700 to perform different tasks that are not disclosed herein. Merely as an illustrative example, the further functionality may comprise a scheduler for scheduling transmissions from the SeNB 2700 and/or for transmissions from wireless devices with which the SeNB 2700 communicates with.

An alternative exemplifying implementation of the SeNB is illustrated in FIG. 28. FIG. 28 illustrates the SeNB 2800 comprising a receiving unit 2803 for receiving, from the MeNB, a request for radio resource modification with regards to a radio resource between the SeNB and the UE, the request comprising a target MeNB radio resource configuration. The SeNB 2800 further comprises a determining unit 2804 for determining an SeNB radio resource configuration between the SeNB and the UE based on the received target MeNB radio resource configuration; and a transmitting unit 2805 for transmitting, to the MeNB, the determined SeNB radio resource configuration.

In FIG. 28, the SeNB 2800 is also illustrated comprising a communication unit 2801. Through this unit, the SeNB 2800 is adapted to communicate with other nodes and/or entities in the wireless communication network. The communication unit 2801 may comprise more than one receiving arrangement. For example, the communication unit 2801 may be connected to both a wire and an antenna, by means of which the SeNB 2800 is enabled to communicate with other nodes and/or entities in the wireless communication network. Similarly, the communication unit 2801 may comprise more than one transmitting arrangement, which in turn is connected to both a wire and an antenna, by means of which the SeNB 2800 is enabled to communicate with other nodes and/or entities in the wireless communication network. The SeNB 2800 further comprises a memory 2802 for storing data. Further, the SeNB 2800 may comprise a control or processing unit (not shown) which in turn is connected to the different units 2803-2805. It shall be pointed out that this is merely an illustrative example and the SeNB 2800 may comprise more, less or other units or modules which execute the functions of the SeNB 2800 in the same manner as the units illustrated in FIG. 28.

It should be noted that FIG. 28 merely illustrates various functional units in the SeNB 2800 in a logical sense. The functions in practice may be implemented using any suitable software and hardware means/circuits etc. Thus, the embodiments are generally not limited to the shown structures of the SeNB 2800 and the functional units. Hence, the previously described exemplary embodiments may be realised in many ways. For example, one embodiment includes a computer-readable medium having instructions stored thereon that are executable by the control or processing unit for executing the method steps in the SeNB 2800. The instructions executable by the computing system and stored on the computer-readable medium perform the method steps of the SeNB 2800 as set forth in the claims.

The SeNB has the same possible advantages as the method performed by the SeNB. The SeNB may be able to maximise the use of the UE's capabilities taking into account the MeNB configuration that would result from the dual connectivity setup/modification action, while ensuring that QoS requirements are fulfilled and UE capabilities are not exceeded.

According to an embodiment, the request for radio resource modification further comprises Radio Access Bearer, RAB, parameters, and UE capabilities, when the SeNB is configured for modifying the radio resource of the SeNB with respect to the UE by adding a RAB between the SeNB and the UE.

According to yet an embodiment, the SeNB is configured for determining the SeNB radio resource configuration with respect to the UE further based on the received UE capabilities and RAB parameters.

According to still an embodiment, the SeNB 2700, 2800 further is configured for receiving, from the MeNB, a new request for radio resource modification with regards to the radio resource between the SeNB and the UE, or a rejection of the SeNB radio resource configuration, for determining a new SeNB radio resource configuration between the SeNB and the UE based on the received target MeNB radio resource configuration; and for transmitting, to the MeNB, the new SeNB radio resource configuration.

According to another embodiment, the new request for radio resource modification further comprises an updated received target MeNB radio resource configuration, wherein the SeNB is configured for determining the new SeNB radio resource configuration based on the received updated target MeNB radio resource configuration.

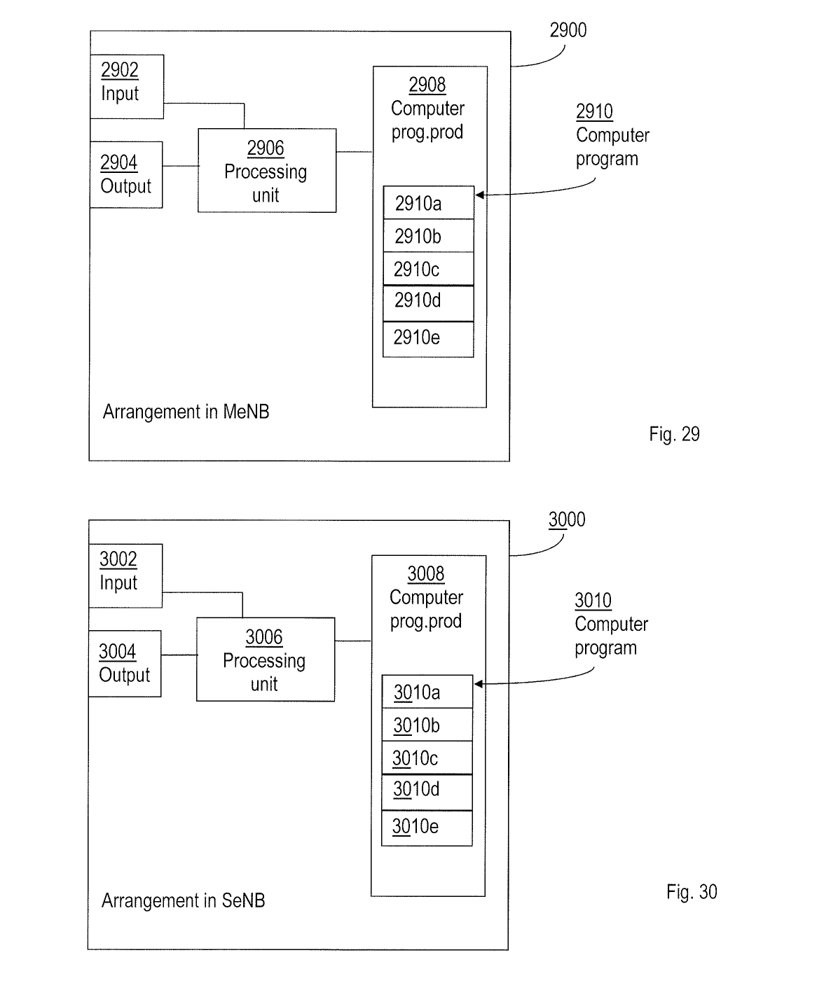

FIG. 29 schematically shows an embodiment of an arrangement 2900 in a MeNB. Comprised in the arrangement 2900 in the MeNB are here a processing unit 706, e.g. with a Digital Signal Processor, DSP. The processing unit 2906 may be a single unit or a plurality of units to perform different actions of procedures described herein. The arrangement 2900 in the MeNB may also comprise an input unit 2902 for receiving signals from other entities, and an output unit 2904 for providing signal(s) to other entities. The input unit and the output unit may be arranged as an integrated entity or as illustrated in the example of FIG. 29, as one or more interfaces 2901.

Furthermore, the arrangement 2900 in the MeNB comprises at least one computer program product 2908 in the form of a non-volatile memory, e.g. an Electrically Erasable Programmable Read-Only Memory, EEPROM, a flash memory and a hard drive. The computer program product 2908 comprises a computer program 2910, which comprises code means, which when executed in the processing unit 2906 in the arrangement 2900 in the MeNB causes the MeNB to perform the actions e.g. of the procedure described earlier in conjunction with FIGS. 23a-23c.

The computer program 2910 may be configured as a computer program code structured in computer program modules 2910a-2910e. Hence, in an exemplifying embodiment, the code means in the computer program of the arrangement 2900 in the MeNB comprises a transmitting unit, or module, for transmitting, to the SeNB, a request for radio resource modification with regards to an SeNB radio resource configuration between the SeNB and the UE, the request comprising a target MeNB radio resource configuration, The computer program further comprises a receiving unit, or module, for receiving, from the SeNB, the SeNB radio resource configuration with regards to the radio resource between the SeNB and the UE.

The computer program modules could essentially perform the actions of the flow illustrated in FIGS. 23a-23c, to emulate the MeNB 2600. In other words, when the different computer program modules are executed in the processing unit 2906, they may correspond to the units 2603-2604 of FIG. 26.

FIG. 30 schematically shows an embodiment of an arrangement 3000 in a SeNB. Comprised in the arrangement 3000 in the SeNB are here a processing unit 3006, e.g. with a Digital Signal Processor. The processing unit 3006 may be a single unit or a plurality of units to perform different actions of procedures described herein. The arrangement 3000 in the SeNB may also comprise an input unit 3002 for receiving signals from other entities, and an output unit 3004 for providing signal(s) to other entities. The input unit and the output unit may be arranged as an integrated entity or as illustrated in the example of FIG. 28, as one or more interfaces 2801.

Furthermore, the arrangement 3000 in the SeNB comprises at least one computer program product 3008 in the form of a non-volatile memory, e.g. an Electrically Erasable Programmable Read-Only Memory, EEPROM, a flash memory and a hard drive. The computer program product 3008 comprises a computer program 3010, which comprises code means, which when executed in the processing unit 3006 in the arrangement 3000 in the SeNB causes the arrangement 3000 in the SeNB to perform the actions e.g. of the procedure described earlier in conjunction with FIGS. 24a-24c.

The computer program 3010 may be configured as a computer program code structured in computer program modules 3010a-3010e. Hence, in an exemplifying embodiment, the code means in the computer program of the arrangement 3000 in the SeNB comprises a receiving unit, or module, for receiving, from the MeNB, a request for radio resource modification with regards to a radio resource between the SeNB and the UE, the request comprising a target MeNB radio resource configuration set. The computer program further comprises a determining unit, or module, for determining a new SeNB radio resource configuration between the SeNB and the UE based on the received target MeNB radio resource configuration. The computer program further comprises a transmitting unit, or module, for transmitting, to the MeNB, the new SeNB radio resource configuration.

The computer program modules could essentially perform the actions of the flow illustrated in FIGS. 24a-24c, to emulate the SeNB 2800. In other words, when the different computer program modules are executed in the processing unit 3006, they may correspond to the units 2803-2805 of FIG. 28.

Although the code means in the respective embodiments disclosed above in conjunction with FIGS. 26 and 28 are implemented as computer program modules which when executed in the respective processing unit causes the MeNB and the SeNB respectively to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the MeNB and the SeNB respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

With the proliferation of user friendly smart phones and tablets, the usage of high data rate services such as video streaming over the mobile network is becoming commonplace, greatly increasing the amount of traffic in mobile networks. Thus, there is a great urgency in the mobile network community to ensure that the capacity of mobile networks keeps up increasing with this ever-increasing user demand. The latest systems such as LTE, especially when coupled with interference mitigation techniques, have spectral efficiencies very close to the theoretical Shannon limit. The continuous upgrading of current networks to support the latest technologies and densifying the number of base stations per unit area are two of the most widely used approaches to meet the increasing traffic demands.

Yet another approach that is gaining high attention is to use Heterogeneous Networks where the traditional pre-planned macro base stations (known as the macro layer) are complemented with several low-powered base stations that may be deployed in a relatively unplanned manner. The 3GPP has incorporated the concept of Heterogeneous Networks as one of the core items of study in the latest enhancements of LTE, such as LTE release 11, and several low-powered base stations to realise heterogeneous networks such as pico base stations, femto base stations (also known as home base stations or HeNBs), relays, and RRHs have been defined.

Initial discussions for LTE release 12 have begun, and one of the proposed items for study is the possibility of serving a UE from more than one eNB simultaneously. The current legacy handover mechanisms of LTE may have to be updated to support this.

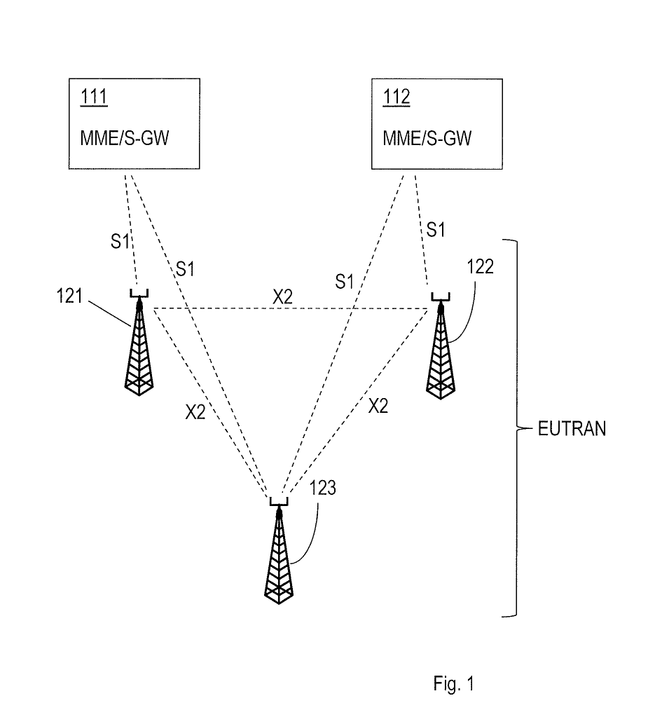

The E-UTRAN includes base stations called enhanced NodeBs, eNBs, providing the E-UTRA user plane and control plane protocol terminations towards the UE. The eNBs are interconnected with each other using the X2 interface. The eNBs are also connected using the S1 interface to the Evolved Packet Core, EPC, more specifically to the Mobility Management Entity, MME, by means of the S1-MME interface and to the Serving Gateway, S-GW, by means of the S1-U interface. The S1 interface supports many-to-many relation between MMEs/S-GWs and eNBs. The E-UTRAN architecture is illustrated in FIG. 1.

The eNB hosts functionalities such as Radio Resource Management, RRM, radio bearer control, admission control, header compression of user plane data towards serving gateway, and/or routing of user plane data towards the serving gateway. The MME is the control node that processes the signalling between the UE and the core network, CN. Significant functions of the MME are related to connection management and bearer management, which are handled via Non Access Stratum, NAS, protocols. The S-GW is the anchor point for UE mobility, and also includes other functionalities such as temporary down link, DL, data buffering while the UE is being paged, packet routing and forwarding to the right eNB, and/or gathering of information for charging and lawful interception. The PDN Gateway, P-GW, is the node responsible for UE IP address allocation, as well as Quality of Service, QoS, enforcement, as further discussed below.

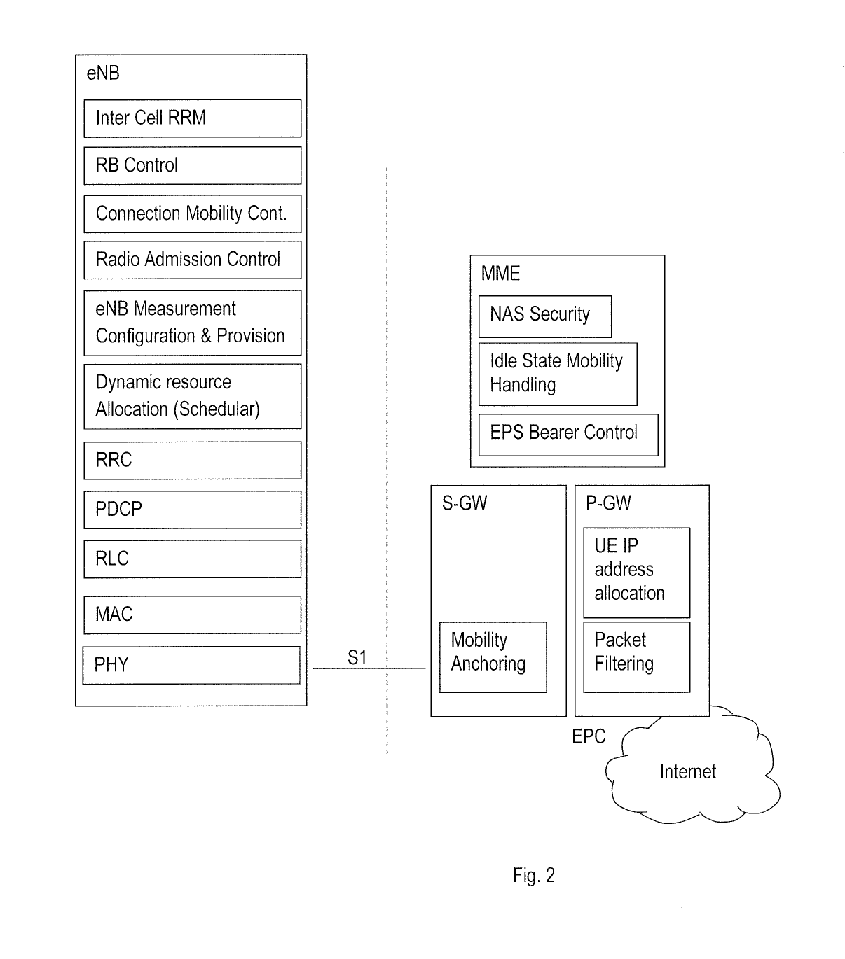

FIG. 2 illustrates a summary of functionalities of the different nodes, and the reader is referred to 3GPP TS 36.300 v.12.3.0 and the references therein for further details of functionalities of the different nodes. In FIG. 2, blocks eNB, MME, S-GW, and P-GW illustrate logical nodes; blocks Inter Cell RRM, RB Control, Connection Mobility Cont., Radio Admission Control, eNB Measurement Configuration & Provision, Dynamic Resource Allocation (Scheduler), NAS Security, Idle State Mobility Handling, EPS bearer Control, Mobility Anchoring, UE IP address allocation, and Packet Filtering illustrate functional entities of the control plane; and blocks RRC, PDCP, RLC, MAC, and PHY illustrate the radio protocol layers.

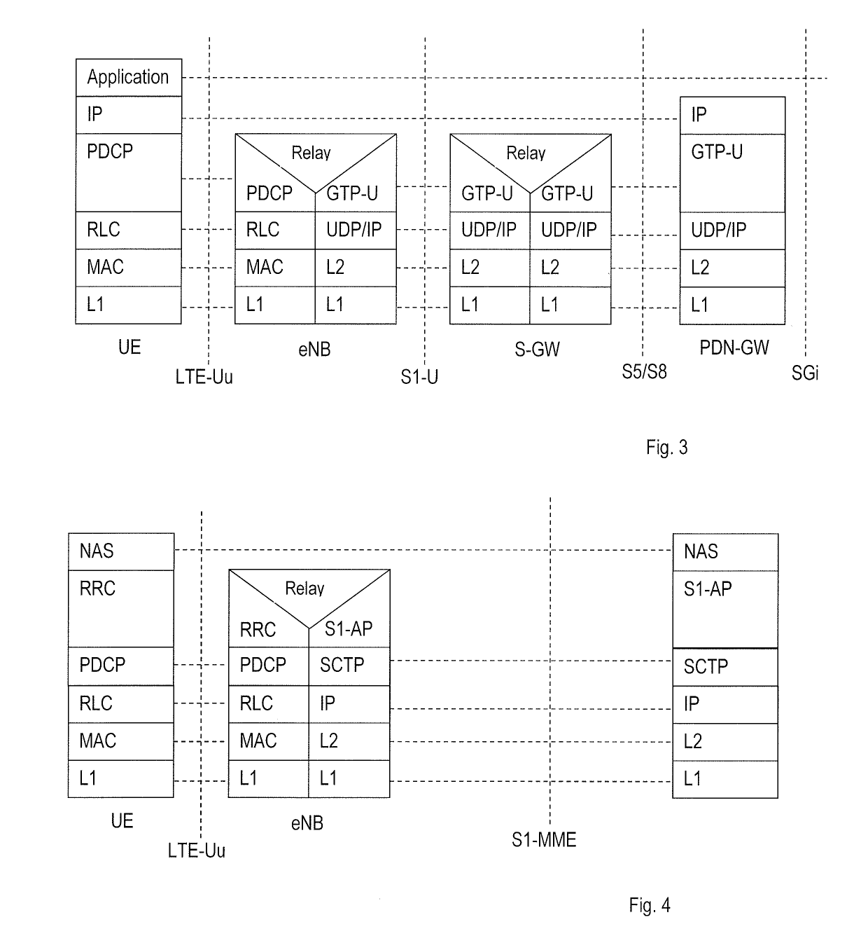

The radio protocol architecture of E-UTRAN is divided into the user plane and the control plane. FIG. 3 illustrates the protocol stack for the user-plane. The user plane protocol stack includes the Packet Data Convergence Protocol, PDCP, Radio Link Control, RLC, and Medium Access Control, MAC, which are terminated at the eNB. The PDCP manages IP packets in the user plane and it performs functionalities such as header compression, security, and re-ordering and retransmission during handover. The RLC layer is mainly responsible for segmentation (and corresponding assembly) of PDCP packets, so that they fit the size that is actually to be transmitted over the air interface. RLC can operate either in unacknowledged mode or acknowledged mode, where the latter supports retransmissions. The MAC layer performs multiplexing of data from different radio bearers, and it is the one that informs the RLC about the size of the packets to provide, which is decided based on the required QoS each radio bearer and the current capacity available to the UE.

FIG. 4 illustrates the control plane protocol stack. The layers below the Radio Resource Control, RRC, layer perform the same functionality as in the user plane, except that there is no header compression in the control plane. The main functions of the RRC are the broadcasting of system information, RRC connection control (establishment, modification, and release of RRC connection, establishment of signalling radio bearers, SRB, and data radio bearers, DRBs, handover, configuration of lower protocol layers, radio link failure recovery, etc.), and measurement configuration and reporting. Details of the RRC protocol functionalities and procedures can be found in 3GPP TS 36.331 v12.3.0.

A UE is uniquely identified over the S1 interface within an eNB with the eNB UE S1AP ID. When an MME receives an eNB UE S1AP ID, the MME stores it for the duration of the UE-associated logical S1-connection for this UE. Once known to an MME, this IE (information element) is included in all UE-associated S1-AP signalling. The eNB UE S1AP ID is unique within the eNB, and a UE is assigned a new S1AP ID after a handover by the target eNB.

From the MME side, a UE is uniquely identified using the MME UE S1AP ID. When an eNB receives MME UE S1AP ID, the eNB stores it for the duration of the UE-associated logical S1 connection for this UE. Once known to an eNB, this IE is included in all UE-associated S1-AP signalling. The MME UE S1AP ID is unique within the MME, and it is changed if the UE's MME changes (for example, handover between two eNBs connected to different MMEs).

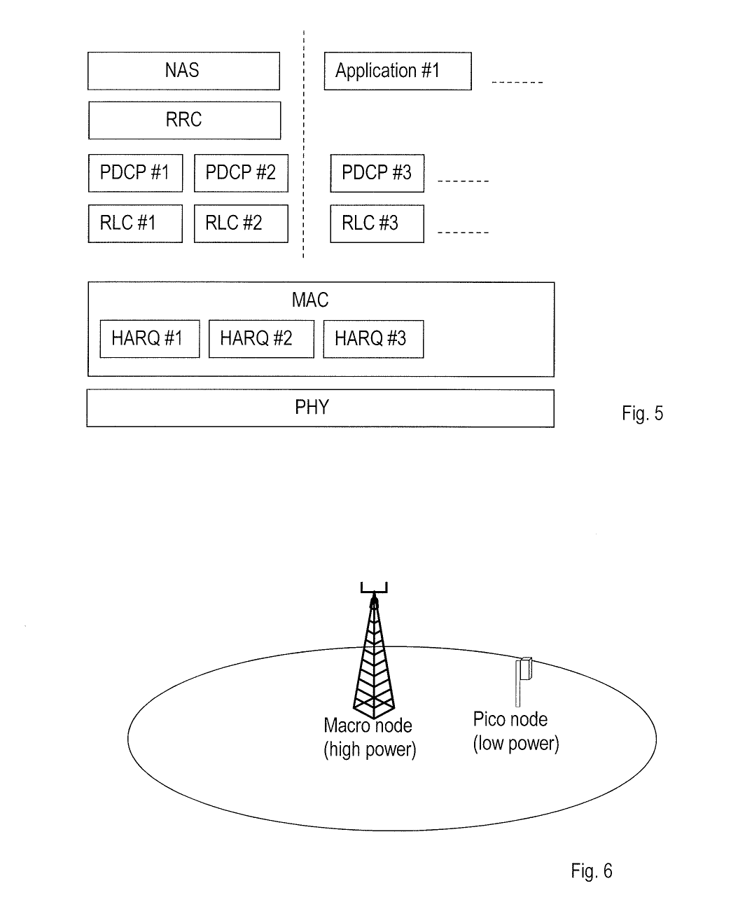

The flow of user plane and control plane data is illustrated in FIG. 5. There is only one MAC entity per UE (unless the UE supports multiple carriers in the case of carrier aggregation), and under this MAC entity several Hybrid automatic repeat request, HARQ, processes might be running simultaneously, for rapid retransmissions. There is a separate RLC entity for each radio bearer and if the radio bearer is configured to use PDCP, there is also one separate PDCP entity for that bearer. A bearer is configured to use PDCP only if it is dedicated to a UE. In other words, multicast and broadcast data do not utilise PDCP both in the control and user plane, and the PDCP is used only for dedicated control message in the control plane and for dedicated UL/DL data in the user plane.

At the transmitting side, each layer receives a Service Data Unit, SDU, from a higher layer, and sends a Protocol Data Unit, PDU, to the lower layer. For example, PDCP PDUs are sent towards the RLC, and they are RLC SDUs from RLC point of view, which in turn sends RLC PDUs towards the MAC, which are MAC SDUs from the MAC point of view. At the receiving end, the process is reversed, i.e. each layer passing SDUs to the layer above it, where they are perceived as PDUs.

A UE can have multiple applications running at the same time, each having different QoS requirements, for example, VoIP, browsing, file download, etc. To support these different requirements, different bearers are set up, each being associated with a respective QoS. An EPS bearer/E-RAB (Radio Access Bearer) is the level of granularity for bearer level QoS control in the EPC/E-UTRAN. That is, Service Data Flows, SDF, mapped to the same EPS bearer receive the same bearer level packet forwarding treatment, e.g. scheduling policy, queue management policy, rate shaping policy, RLC configuration, etc.

One EPS bearer/E-RAB is established when the UE connects to a Packet Data Network, PDN, and that remains established throughout the lifetime of the PDN connection to provide the UE with always-on IP connectivity to that PDN. That bearer is referred to as the default bearer. Any additional EPS bearer/E-RAB that is established to the same PDN is referred to as a dedicated bearer. The initial bearer level QoS parameter values of the default bearer are assigned by the network, based on subscription data. The decision to establish or modify a dedicated bearer can only be taken by the EPC, and the bearer level QoS parameter values are always assigned by the EPC.

The packets of an EPS bearer are transported over a radio bearer between the UE and eNB. An S1 bearer transports the packets of an EPS bearer between the eNB and S-GW. An E-RAB is actually a concatenation of these two bearers (i.e. radio bearer and S1 bearer), and the two bearers are mapped on a one to one fashion. An S5/S8 bearer transports the packets of the EPS bearer between the S-GW and P-GW, and completes the EPS bearer. Here also there is a one to one mapping between the E-RAB and S5/S8 bearer.

A heterogeneous deployment or heterogeneous network, as illustrated in FIG. 6, includes network transmission nodes, e.g. micro and pico nodes or base stations, operating with different transmit powers and with overlapping coverage areas. A heterogeneous deployment/network is considered as an interesting deployment strategy for cellular networks. In such a deployment, the low-power nodes (“pico nodes”) are typically assumed to offer high data rates (Mbit/s) and/or to provide increased/high capacity (users/m2 or Mbit/s/m2) in the local areas where increased data rates/capacity is/are needed/desired, while the high-power nodes (“macro nodes”) are assumed to provide full-area coverage. In practice, the macro nodes may correspond to currently deployed macro cells while the pico nodes are later deployed nodes, provided to extend capacity and/or achievable data rates within the macro-cell coverage area where needed/desired. FIG. 6 illustrates a heterogeneous deployment with a higher-power macro node and a lower-power pico node. In a typical case, there may be multiple pico nodes within the coverage area of a macro node.

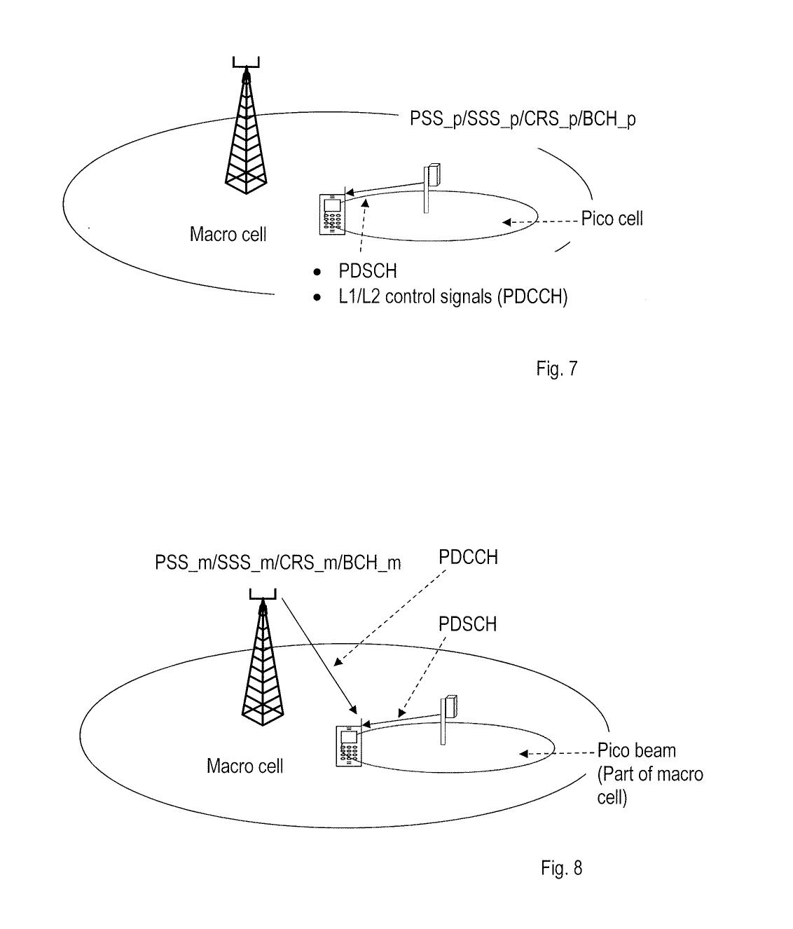

A pico node of a heterogeneous deployment may operate as a cell of its own (a “pico cell”) as shown in FIG. 7. This means that, in addition to downlink and uplink data transmission/reception, the pico node also transmits the full set of common signals/channels associated with a cell. In the LTE context this full set of common signals/channels includes:
The Primary and Secondary Synchronisation Signals, PSS and SSS, corresponding to the Physical Cell Identity of the pico cell.
The Cell-specific reference signals, CRS, also corresponding to the Physical Cell Identity of the cell. The CRS can, for example, be used for downlink channel estimation to enable coherent demodulation of downlink transmissions.
The Broadcast channel, BCH, with corresponding pico-cell system information. Additional system information may also be transmitted on the PDSCH physical channel.

As the pico node transmits the common signals/channels, the corresponding pico cell can be detected and selected (connected to) by a UE.

If the pico node corresponds to a cell of its own, also so-called L1/L2 control signalling on the Physical Downlink Control Channel of PDCCH (as well as Physical Control Format Indicator Channel or PCFICH and Physical Hybrid-ARQ Indicator Channel or PHICH) are transmitted from the pico node to connected terminals, in addition to downlink data transmission on the Physical Downlink Shared Channel or PDSCH. The L1/L2 control signalling, for example, provides downlink and uplink scheduling information and Hybrid-ARQ-related information to terminals within the cell. This is shown in FIG. 7.

FIG. 7 illustrates a heterogeneous deployment where the pico node corresponds to a cell of its own (a “pico cell”). The indices “p” and “m” indicate common signals/channels for the pico and macro cell respectively. As shown in FIG. 7, the pico node uses/transmits its own primary and secondary synchronisation signals PSSp and SSSp, cell specific reference signals CRSp, and broadcast channel BCHp that are independent of (e.g. different than) the primary and secondary synchronisation signals PSSm and SSSm, cell specific reference signals CRSm, and broadcast channel BCHm used/transmitted by the macro node. Accordingly, the UE may communicate through the pico node without support from the macro node.

Alternatively, a pico node within a heterogeneous deployment may not correspond to a separate cell of its own, but may instead provide a data-rate and/or capacity “extension” of the overlaid macro cell. This is sometimes known as “shared cell” or “soft cell”. In this case, at least the CRS, physical broadcast channel, PBCH, PSS and SSS are transmitted from the macro node, but not the pico node. The PDSCH can be transmitted from the pico node. To allow for demodulation and detection of the PDSCH, despite the fact that no CRS is transmitted from the pico node, DeModulation reference signal, DM-RS, may be transmitted from the pico node together with the PDSCH. The UE-specific reference signals can then be used by the terminal for PDSCH demodulation/detection. This is shown in FIG. 8, which illustrates a heterogeneous deployment where the pico node does not correspond to or define a cell of its own.

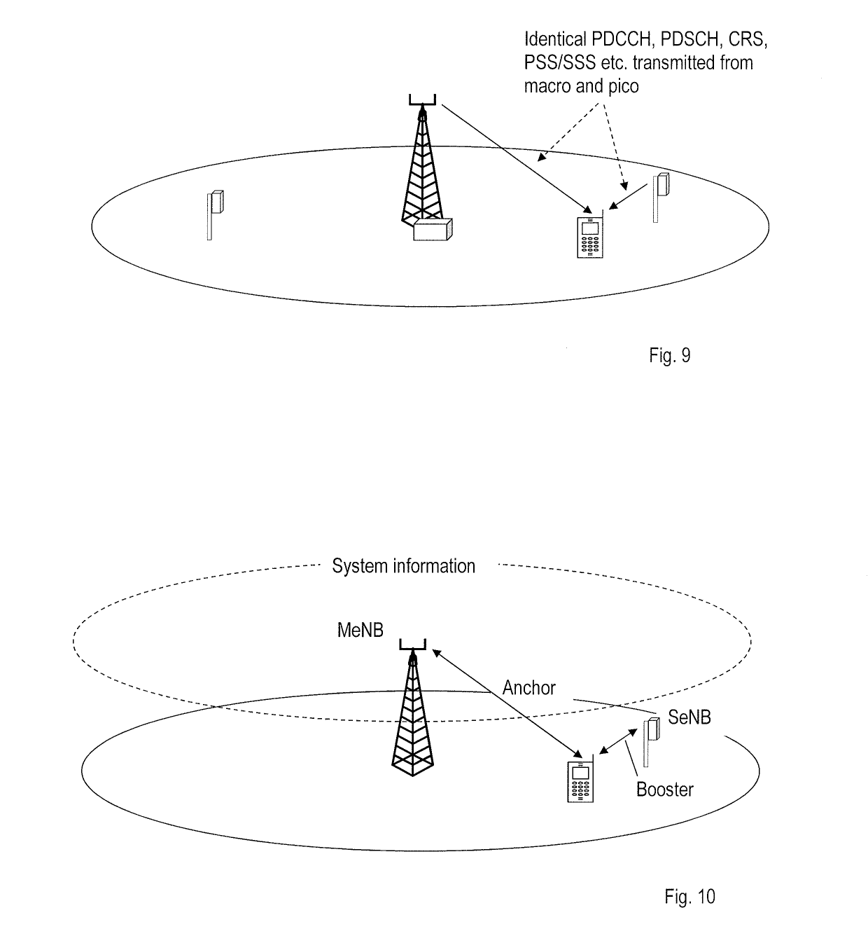

Transmitting data from a pico node not transmitting CRS as described above may require DM-RS support in/at the UE (“non-legacy terminal”). In LTE, DM-RS-based PDSCH reception is supported in Rel-10 and for Frequency Division Duplex, FDD, while for the L1/L2 control signalling, DM-RS-based reception is planned for Rel-11. For terminals not supporting DM-RS-based reception (“legacy terminals”) one possibility in a shared cell setting is to exploit SFN-type (Single Frequency Network type) of transmission. In essence identical copies of the signals and channels necessary for a legacy terminal are transmitted simultaneously from the macro and pico nodes. From a terminal perspective, this will look as a single transmission. Such an operation, which is illustrated in FIG. 9, may only provide a Signal to Interference and Noise Ration, SINR, gain, which can be translated into a higher data rate but not a capacity improvement, because transmission resources cannot be reused across sites within the same cell. As shown in FIG. 10, SFN operation may be provided with identical transmissions from macro and pico to a UE.

Assume that the macro nodes are able to provide coverage and the pico nodes are provided only for capacity enhancements (i.e. to reduce coverage holes), another alternative architecture is where the UE maintains connectivity to the macro node, or, more generally, the “Master eNB”, MeNB, all the time, and adds connectivity to the pico node, or, more generally, the “Secondary eNB”, SeNB, when it is in the coverage area of the pico node. The link between the UE and the MeNB may be referred to as the “anchor” link, while the link between the UE and SeNB can be referred to as the “booster” link. When both connections are active, the anchor link can be used for control signalling while the booster link is used for data. In addition, it may also be possible to send data via the anchor link. This is illustrated in FIG. 10. In this case, as in the previous cases, the system information is shown to be sent only from the MeNB, but it is still possible to send it also from the SeNB. As shown in FIG. 10, in soft cell operation, the UE may have multiple connections with both the anchor and booster nodes, also referred to as the macro and pico nodes.

The term “dual connectivity” is used to refer to operation where the UE consumes radio resources provided by at least two different network points connected with non-ideal backhaul. Furthermore, each eNB involved in dual connectivity for a UE may assume different roles. Those roles do not necessarily depend on the eNB's power class and can vary among UE.

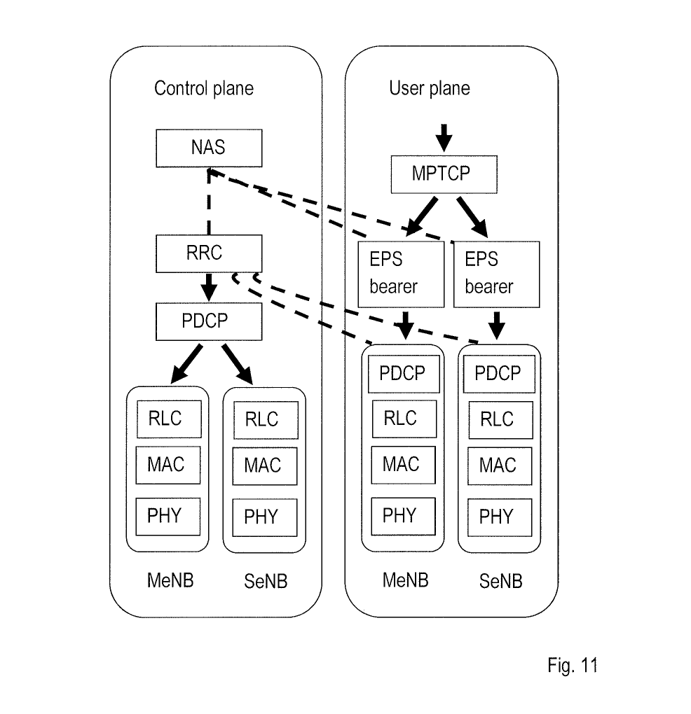

To support multiple connectivity to micro and pico nodes, several architectural options are possible both for the control and user planes. For the user plane, a centralised approach may be provided where the PDCP, or even the RLC, terminated at the anchor node only and the booster node terminates at the RLC, or even the MAC, level. A decentralised approach may be to have the booster to terminate at the PDCP level. A similar approach can be taken in the control plane, i.e., distributed or centralised PDCP/RLC, but on top of that the additional dimension of centralising or distributing the RRC may be provided. FIG. 11 shows example control and user plane architectures where the user plane uses distributed PDCP, while the control plane is centralised at the PDCP level at the anchor node. Note that in FIG. 11, user plane aggregation (i.e. the possibility to split the packets belonging to one application data flow over the anchor and booster links) can be realised by using a higher layer aggregation protocol like multi-path TCP, MTCP.

Random access, RA, serves as an uplink control procedure to enable the UE to access the network. The RA procedures serve three main purposes:
The RA procedures let the UE align its uplink, UL, timing to that expected by the eNodeB in order to minimise interfering with other UEs transmissions. UL time alignment is a requirement in E-UTRAN before data transmissions can commence.
The RA procedures provide a means for the UE to notify the network of its presence and enable the eNodeB to give the UE initial access to the system.
The RA procedures notify the eNB that the UE has data in its uplink buffer.

In addition to its usage during initial access, the RA procedures are also used when the UE has lost the uplink synchronisation.

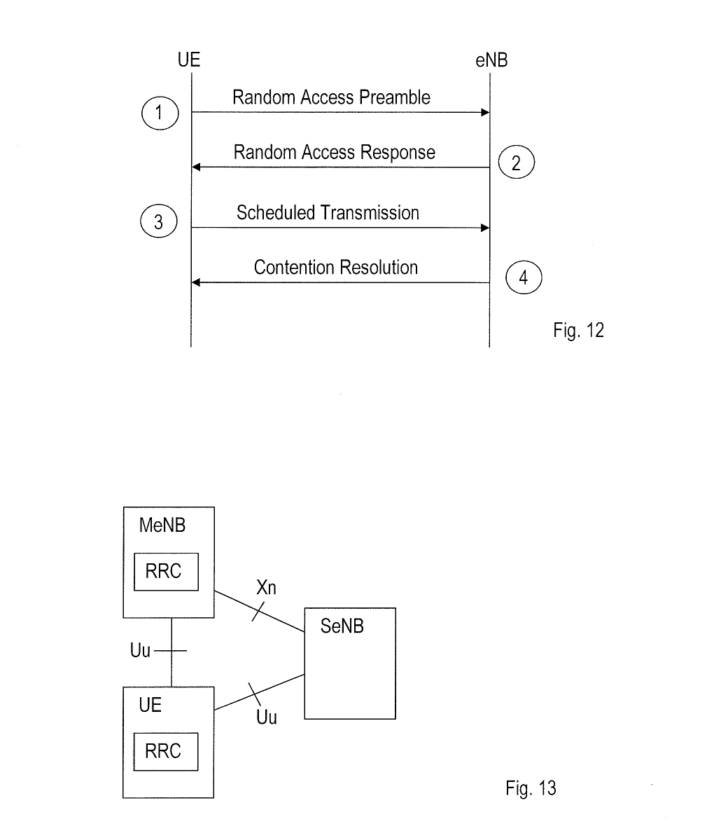

The basic RA Procedure is a four-phase procedure as outlined in FIG. 12.
Phase 1 consists of transmission of a random access preamble by the UE, allowing the eNB to estimate the transmission timing of the UE. Uplink synchronisation is necessary as the UE otherwise cannot transmit any uplink data. The preamble used in this step can be either randomly selected by the UE in contention-based Random Access procedures, or dedicated by the network in contention-free Random Access procedures. The latter solution can be used in case of handover, for example, when the target eNB may signal dedicated random access information to the source eNB, which will further convey that information to the UE.
Phase 2 consists of the network transmitting the Random Access Response message. This message includes the timing advance command to correct the uplink timing, based on the timing of arrival measurement in the first step. In addition to establishing uplink synchronisation, the second step also assigns uplink resources. In the case of contention based random access, a temporary identifier to the UE is included, to be used in the third step in the random access procedure.
Phase 3 consists of signalling from the UE to the eNB, also called as Msg3. This step is included in contention-based Random Access. A primary function of this message is to uniquely identify the UE. The exact content of this signalling depends on the state of the UE, e.g. whether it is previously known to the network or not. In connected state, the UE includes at least its C-RNTI in the Msg3.
Phase 4, the final phase, is responsible for contention resolution to solve the potential case when in case multiple UEs tried to access the system on the same resource. This phase is used in contention-based Random Access procedure.

The UE obtains information about which preambles are available, either to select one at random or to use a specified one, whether one or repeated preambles should be used, what the desired received power level should be at the base station, what power increase step should be used in case of failed preamble reception, what the maximum number of random access preamble transmission is, when it is allowed to transmit the preamble, etc.

If the UE obtains the Phase I information via dedicated signalling, such as when random access is performed as part of handover (the dedicated signalling originated from the target cell, forwarded to the UE by the serving cell), a specific preamble may be configured. In addition, the timer T304 is started with a value provided by the dedicated signalling.

The UE determines a random access resource for preamble transmission in consideration of the retrieved information. Either, the information is related to the downlink synchronisation of the serving cell, or related to a non-serving cell. The latter can be the case when random access is used to get established in a target cell during handover.

The UE monitors PDCCH of the cell for random access response in the RA response window, which starts at the subframe that contains the end of the preamble transmission plus three subframes and has the length ra-ResponseWindowSize.

If no response has been received, and the max number of preamble transmissions has been reached, or the timer T304 has expired, the handover attempt is considered failed and higher layer is informed. Then, the UE initiates the RRC connection reestablishment procedure to restore the connection to the source cell, specifying the reestablishment cause to handover failure. Furthermore, a radio link failure report is prepared.

There are currently different options for control plane termination for dual connectivity. The option considered here is where the UE has one single RRC entity, which communicates with a single RRC entity located in the MeNB on the network side. This is shown in FIG. 13. In this scenario, all control signalling between the UE and the network terminates in the MeNB. Only the MeNB generates the final RRC messages to be sent towards the UE after coordination of RRM functions between MeNB and SeNB. The UE RRC entity sees all messages coming only from one entity (in the MeNB) and the UE only replies back to that entity.

Note, that one option could foresee a “virtual RRC” entity in the SeNB that generates parts of the RRC message to be finally sent to the UE by the MeNB. This scheme is similar to the case of handover, HO, where the target eNB generates the RRC message to be sent to the UE by the source eNB. The difference between the dual-connectivity situation scenario presented here and HO is that in the former scenario the MeNB may need to check the contents of the partial RRC message and assemble the final RRC message.

In the following, it can be assumed that each node controls its own radio resources. This is necessary, since an eNB acting as SeNB towards one UE may at the same time act as MeNB towards another UE. In other words, MeNB and SeNB are UE-specific roles of an eNB. Thus, to ensure efficient usage of radio resources, each eNB must be in control of its own radio resources and a distributed RRM needs to be assumed.

There is a need for a procedure between the MeNB and the SeNB to agree on the UE radio resource configuration. For instance, a procedure is needed to enable the setup, the modification or the handover of a UE bearer for which radio resources are provided by a radio network node (SeNB) that is different from the radio network node (MeNB) that hosts the RRC connection and the connection to the core network. In addition, there might be a need to modify the physical or MAC layer RRC configuration used in the SeNB.

One important thing to consider here are the UE capabilities. The UE capabilities indicate whether the UE supports some features (static), but also indicate what are the maximum amounts of certain radio resources that can be allocated (dynamically) to the UE (e.g. number of ROHC context sessions).

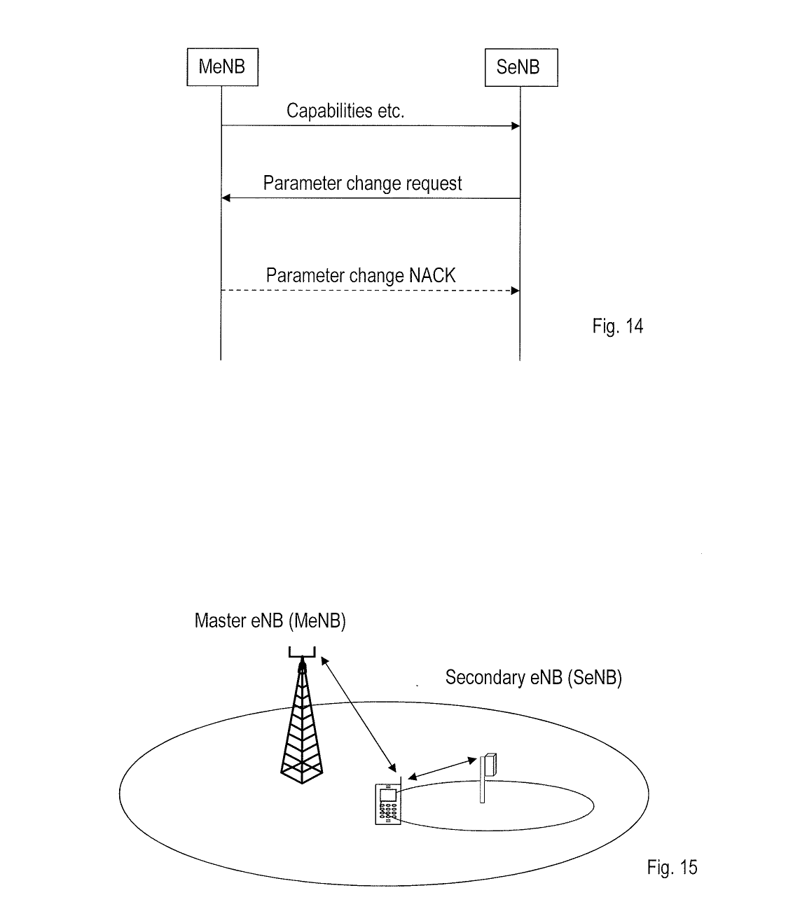

The assumed procedure for negotiating radio resource configuration of the connection between the UE and the SeNB is shown in FIG. 14, and involves the following steps:
1. MeNB provides current radio resource configurations and capabilities of the UE for the SeNB over Xn. This may be done within the message that triggers the setup of resources within the SeNB.
2. The SeNB decides the radio resource configuration relevant for the SeNB and signals this to the MeNB over Xn. This may be done in response to the message triggering the setup of resources within the SeNB or during triggering the modification of already established resources.
3. The MeNB either accepts the radio resource configuration relevant for the SeNB, or rejects it and sends a NACK to the SeNB. If the parameter negotiation function was triggered during setup/HO of resources towards the SeNB, there might not be the need for an explicit ACK. In case of resource modification, if the radio resource configuration is accepted by the MeNB, it replies ACK back to the SeNB. If not, a NACK is sent.

The benefits of this solution are as follows:
the current model with SRB1/SRB2 is sufficient,
It requires only one set of PDCP encryption keys for control plane,
One entity takes the final decision->no risk of exceeding capabilities, and
No need for parallel procedures for the UE (current model applies).

Dual connectivity may be defined from the UE perspective wherein the UE may simultaneously receive and transmit to at least two different network points. Dual connectivity is one of the features that are being standardised within the umbrella work of small cell enhancements within 3GPP Rel-12.

Dual connectivity may be defined for the case when the aggregated network points operate on the same frequency or in separate frequencies. In Rel-12, the focus has been on supporting deployments on separate frequencies. Further in Rel-12, it is assumed that the UE is capable of simultaneously receiving and transmitting from two different nodes. Dual connectivity as a feature bears many similarities with carrier aggregation and Coordinated Multi Point, CoMP; the main differentiating factor is that dual connectivity is designed considering a relaxed backhaul and less stringent requirements on synchronisation between the network points. This is in contrast to carrier aggregation and CoMP, wherein, before Rel-12, tight synchronisation and a low-delay backhaul have been assumed between connected network points.

A UE in dual connectivity maintains simultaneous connections to MeNB and SeNB nodes as illustrated in FIG. 15.

As the name indicates, the MeNB terminates the control plane connection towards the UE and is thus the controlling node of the UE. In addition to the MeNB, the UE may be connected to one or several SeNBs for added user plane support. In Rel-12, the number of SeNBs is limited to one however more SeNBs may be supported in future releases.

The MeNB and SeNB roles are defined from a UE point of view. This means that an eNB that acts as an MeNB to one UE may act as SeNB to another UE.

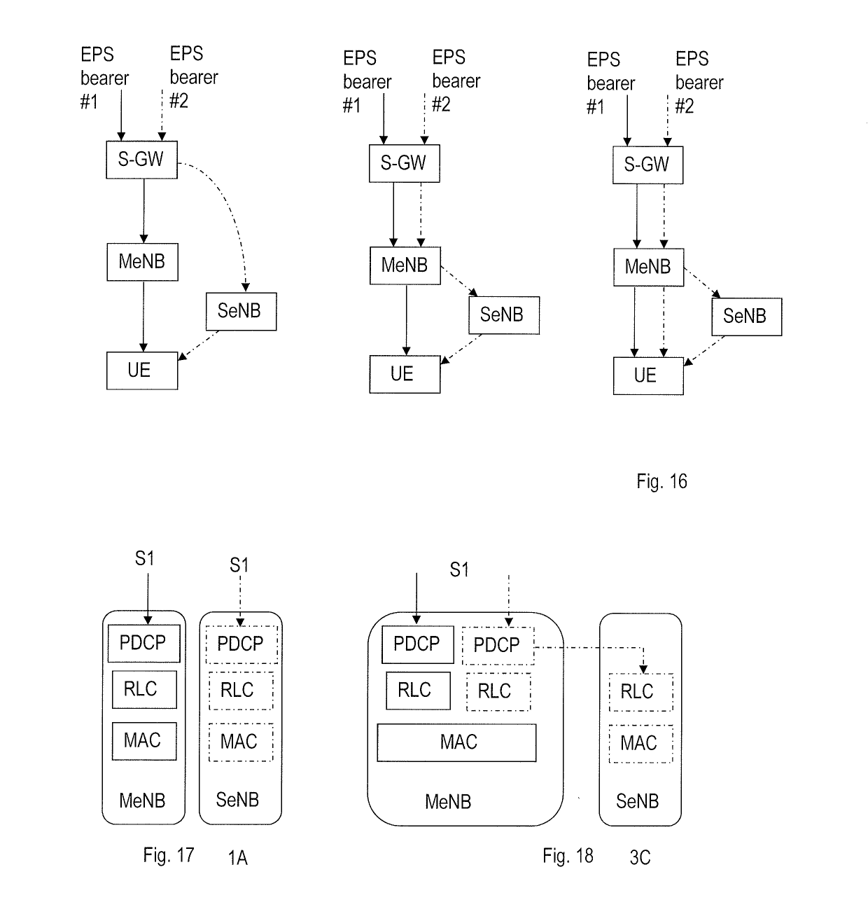

FIG. 16 illustrates three options for splitting the U-Plane data. The main differentiating factors between the three options lies in the backhaul usage and the support for data split within or between EPS bearers. (1) Option 1: S1-U terminates in SeNB. (2) Option 2: S1-U always terminates in MeNB, no bearer split in RAN. (3) Option 3: S1-U always terminates in MeNB, bearer split in RAN.

Considering these three options, it is unclear whether one single option will suit all aspects. Given a non-ideal backhaul with limited capacity, option 1 is most appropriate since it avoids the routing of user plane data via the MeNB, creating possible bottlenecks. With option 1, improved mobility robustness by separating control and user plane termination can be achieved but implies signalling towards the CN for the path switch. This can be used to maintain a robust control plane connection with the macro layer, while offloading user plane traffic to the pico layer for improved throughput.

Furthermore, option 1 also allows user plane aggregation. Multi-path TCP, MPTCP, can be used to split the data between the two EPS bearers. The main principle of MPTCP is to aggregate a certain TCP connection over multiple paths. MPTCP has one main flow and multiple sub flows and is capable of distributing load on all interfaces. MPTCP is currently under standardisation process within Internet Engineering Task Force, IETF. As the multiplexing of different connections is on TCP level, it allows separate congestion control for each sub flow, overcoming the bottleneck problem of the first option discussed above. Though aggregation via MPTCP is applicable only for TCP based traffic, this will not be a big disadvantage as the majority of Internet/mobile broadband data is TCP based. MPTCP may also be implemented in a MPTCP proxy, so it doesn't need to be E2E. For small object sizes, MPTCP can give gain from parallel slow start phases. Further study is needed to evaluate the performance of option 1 and MPTCP.

However, in deployments where backhaul capacity is not an issue, option 3 may provide higher expected user resource aggregation gains through intra bearer user plane aggregation as the splitting point is closer to the radio interface, compared with option 1. However, it requires L2 to cater for splitting, flow control and reordering. Option 2 is similar to option 3, but would miss the opportunities for user plane aggregation gains, although it assumes high backhaul capacity. Considering the aforementioned and other aspects, options 1 and 3 are currently within the scope of the Rel-12 work item.

For bearer split option 1, the user plane protocol termination 1A is shown in FIG. 17. For bearer split option 3, several protocol termination options can be envisioned, depending on where in the protocol stack the data is split. For Rel-12, a protocol split shown in FIG. 18 was selected, labelled 3C.

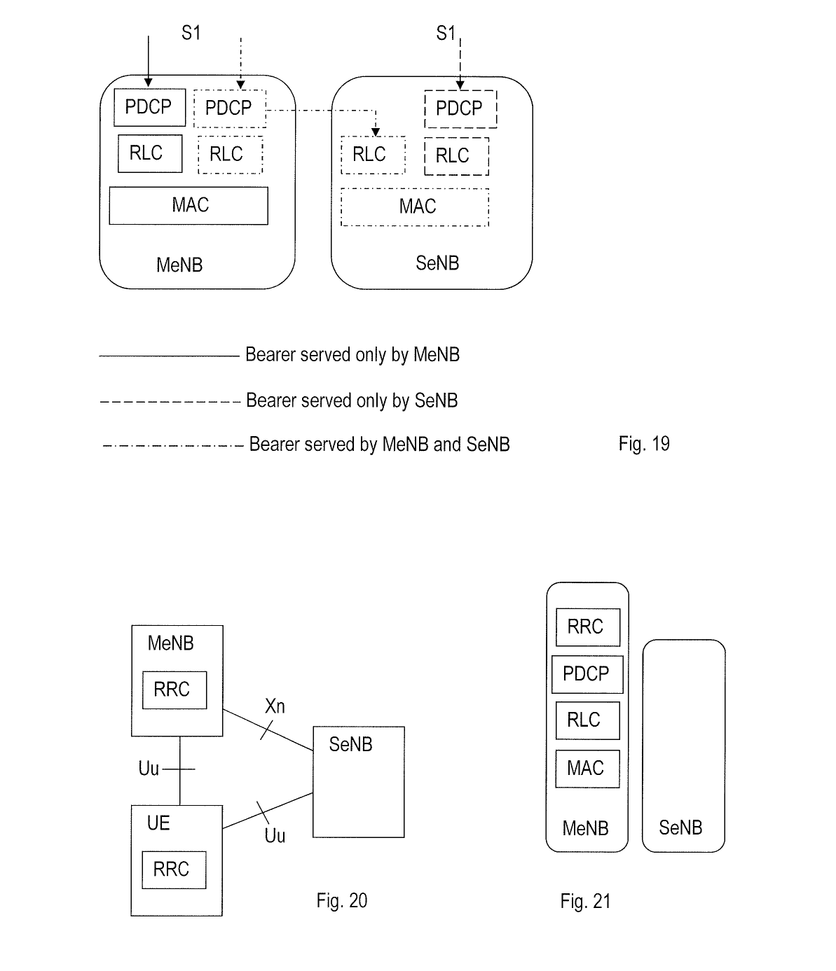

The selected user plane architecture options 1A and 3C should preferably not result in different specifications, but should rather be a configuration option. Therefore, it was proposed to have a common architecture with 3 types of bearers rather than two different architectures. In FIG. 19, the common architecture for user plane architectures 1A and 3C is drawn, illustrating three bearer types and their termination points. In the common architecture, there are three types of bearers:
A bearer only served by MeNB, referred to as Master Cell Group, MCG, Data Radio Bearer, DRB, i.e. a DRB for which resources are provided by the Master Cell Group.
A bearer only served by SeNB, referred to as Secondary Cell Group (SCG DRB), i.e. a DRB for which resources are provided by the Secondary Cell Group.
A bearer served by MeNB and SeNB, referred to as split DRB.

Both contention-free and contention-based RA procedures are supported towards the SeNB. Parallel RA procedures are supported if RA Preamble transmissions do not overlap, no requirement to coordinate Physical Random Access Channel, PRACH, resource in network side.

If a bearer is mapped into either MeNB or SeNB resources, the UE sends Buffer Status Report, BSR, information for that bearer to the eNB which owns that bearer.

Working assumption is to have separate Discontinuous Reception, DRX, configurations and operations (timers and active time).

Activation and deactivation are supported for SCG. MeNB can activate and deactivate Cells associated with MeNB. SeNB can activate and deactivate cells associated with SeNB.

It is agreed to have two MAC entities in the UE side in dual connectivity operation: UE side MAC entity is configured per Cell Group, i.e. one MAC for MCG and the other MAC for SCG.

Flow control for 3C was identified as a necessity; it is only for further study whether it is defined as X2 UP or L2 UP function.

The control plane architecture is designed along the following principles:
each eNB is able to handle UEs autonomously, i.e., provide the Primary Cell, PCell, to some UEs while acting as SeNB for other;
there will be only one S1-MME Connection per UE;
each eNB involved in dual connectivity (DC) owns its radio resources, however some coordination is still needed between MeNB and SeNB;
a UE always stays in a single RRC state, i.e., either RRC_CONNECTED or RRC_IDLE.

FIG. 20 illustrates the control plane architecture. The MeNB generates the final RRC messages to be sent towards the UE after the coordination of RRM functions between MeNB and SeNB. The UE RRC entity sees all messages as coming only from one entity (in the MeNB) and the UE only replies back to that entity.

In Rel-12, L2 protocol termination for the control plane is made in MeNB, see FIG. 21. No further enhancements to the L2 protocols are required with this approach.

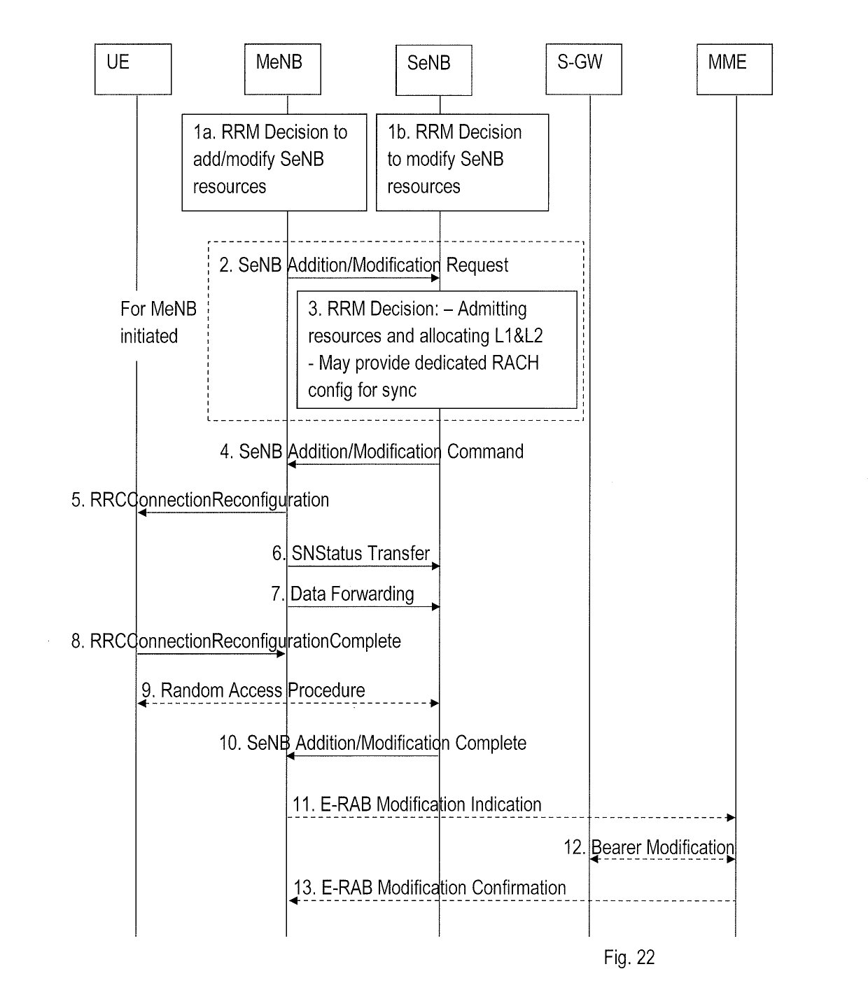

FIG. 22 depicts a preliminary overall signalling scheme captured in the study item TR 36.842 [6] for addition and modification of SeNB resources for dual connectivity operation, based on decisions taken in RAN2 during the study item phase. The same basic procedure is expected to be applicable to MCG DRBs, SCG DRBs and split DRBs. The signalling scheme was provided for the Technical Report (TR) mainly to reveal similarities between addition and modification signalling schemes.

As depicted in FIG. 22, activating/modifying resources at SeNB for dual connectivity operation could involve the following steps:

1a. The MeNB decides to request the SeNB to add or modify radio resources for a specific E-RAB.

1b. The SeNB decides to modify radio resources for a specific E-RAB.

This step may include additional coordination between the SeNB and MeNB to make sure that e.g. the capabilities of the UE are not exceeded

2. The MeNB requests the SeNB to allocate/modify radio resources. Depending on the actual scenario, it might contain E-RAB characteristics (E-RAB parameters, TNL address information corresponding to the UP option), UE Capabilities and the current radio resource configuration of the UE etc.

3. If the RRM entity in the SeNB is able to admit the resource request, it configures respective radio resources and, dependent on the UP option, respective transport network resources. The SeNB may also allocate dedicated RACH preamble for the UE so that synchronisation of the SeNB radio resource configuration can be performed.

4. The SeNB provides the new radio resource configuration to the MeNB (for UP alternative 1A it may contain, dependent on the actual scenario, S1 DL TNL address information for the respective E-RAB, for UP alternative 3C X2 DL TNL address information).

5. The MeNB endorses the new configuration and triggers the UE to apply it. The UE starts to apply the new configuration.

6./7. In case of UP option 1A the MeNB may, dependent on respective E-RAB characteristics, take actions to minimise service interruption due to activation of dual connectivity (Data forwarding, SN Status Report). Note: Whether the UP resources established for data forwarding for UP option 1A need to be released explicitly may be further discussed.

8. The UE completes the reconfiguration procedure. Note: In case of UP options 3C, transmission of user plane data from the SeNB to the UE may take place after step 8 or 9 depending on the synchronisation procedure.

9. The UE performs synchronisation towards the cell of the SeNB if needed.

10. The SeNB reports to MeNB the detection of synchronisation with the UE, confirming that the new configuration is in use. Receipt of the message in step 10 by the MeNB successfully completes the overall SeNB Addition/Modification procedure on X2. Note: Depending on the decision on the order of RRC reconfiguration and synchronisation or on the support of synchronisation, step 10 might be either necessary as described above or in the reverse direction (from MeNB to SeNB).

11.-13. For UP option 1A, if applicable, the update of the UP path towards the EPC is performed.

Note: FIG. 22 assumes that S-GW is not changed.

In step 2 of the current procedure for SeNB resource addition/modification, the MeNB sends a request for SeNB resources to the SeNB, the request including the current radio resource configuration of the UE, that the MeNB is using.

A problem with using the current radio resource configuration is that the MeNB may also decide to change its configuration as a result of the procedure. Consider for instance the situation where one DRB is being moved from the MeNB to the SeNB. In that case the MeNB configuration will change so that resources are released that can be used by the SeNB when selecting its configuration. Therefore, if the MeNB only provides its current radio resource configuration, the SeNB will have no means of knowing whether these resources can be taken into use.

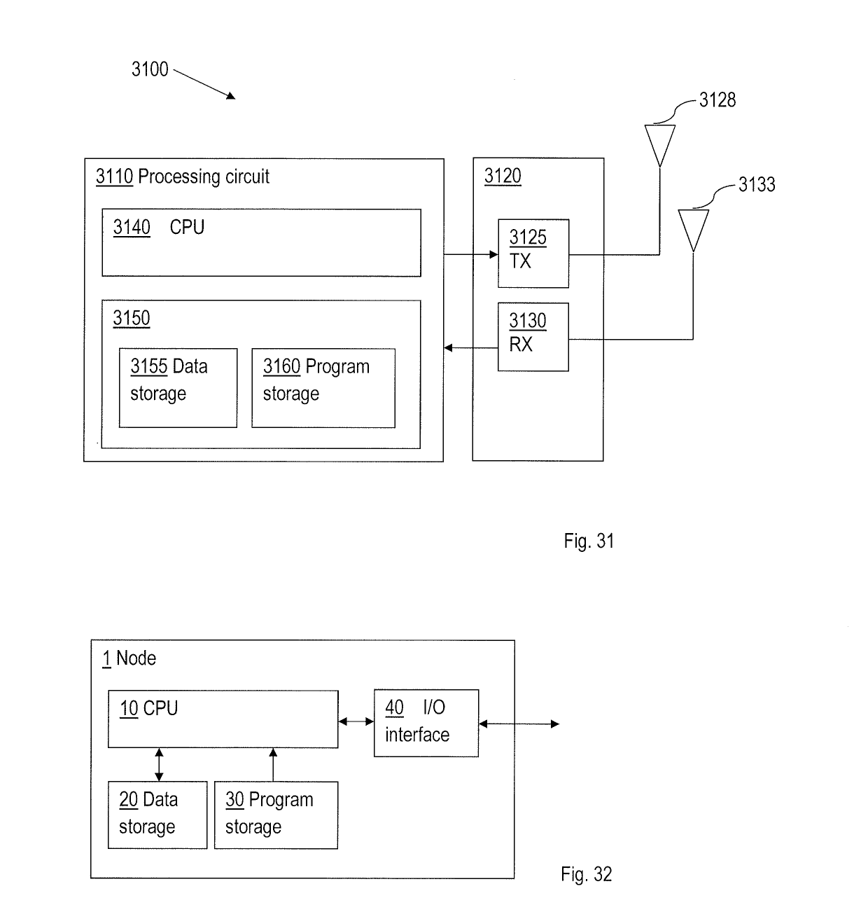

FIG. 31 illustrates features of an example terminal 3100 according to several embodiments of the present invention. Terminal 3100, which may be a UE configured for dual-connectivity operation with an LTE network (E-UTRAN), for example, comprises a transceiver unit 3120 for communicating with one or more base stations as well as a processing circuit 3110 for processing the signals transmitted and received by the transceiver unit 3120. Transceiver unit 3120 includes a transmitter 3125 coupled to one or more transmit antennas 3128 and receiver 3130 coupled to one or more receiver antennas 3133. The same antenna(s) 3128 and 3133 may be used for both transmission and reception. Receiver 3130 and transmitter 3125 use known radio processing and signal processing components and techniques, typically according to a particular telecommunications standard such as the 3GPP standards for LTE. Note also that transmitter unit 3120 may comprise separate radio and/or baseband circuitry for each of two or more different types of radio access network, such as radio/baseband circuitry adapted for E-UTRAN access and separate radio/baseband circuitry adapted for Wi-Fi access. The same applies to the antennas—while in some cases one or more antennas may be used for accessing multiple types of networks, in other cases one or more antennas may be specifically adapted to a particular radio access network or networks. Because the various details and engineering trade-offs associated with the design and implementation of such circuitry are well known and are unnecessary to a full understanding of the invention, additional details are not shown here.

Processing circuit 3110 comprises one or more processors 3140 coupled to one or more memory devices 3150 that make up a data storage memory 3155 and a program storage memory 3160. Processor 3140, identified as CPU 3140 in FIG. 31, may be a microprocessor, microcontroller, or digital signal processor, in some embodiments. More generally, processing circuit 3110 may comprise a processor/firmware combination, or specialised digital hardware, or a combination thereof. Memory 3150 may comprise one or several types of memory such as read-only memory (ROM), random-access memory, cache memory, flash memory devices, optical storage devices, etc. Because terminal 3100 supports multiple radio access networks, processing circuit 3110 may include separate processing resources dedicated to one or several radio access technologies, in some embodiments. Again, because the various details and engineering trade-offs associated with the design of baseband processing circuitry for mobile devices are well known and are unnecessary to a full understanding of the invention, additional details are not shown here.

Typical functions of the processing circuit 3110 include modulation and coding of transmitted signals and the demodulation and decoding of received signals. In several embodiments of the present invention, processing circuit 3110 is adapted, using suitable program code stored in program storage memory 3160, for example, to carry out one of the techniques described above for access network selection. Of course, it will be appreciated that not all of the steps of these techniques are necessarily performed in a single microprocessor or even in a single module.

A more general illustration of a network node, e.g. the MeNB and the SeNB, is shown in FIG. 32. Several of the techniques and processes described above can be implemented in a network node, such as an eNodeB or other node in a 3GPP network. FIG. 25 is a schematic illustration of a node 1 in which a method embodying any of the presently described network-based techniques can be implemented. A computer program for controlling the node 1 to carry out a method embodying the present invention is stored in a program storage 30, which comprises one or several memory devices. Data used during the performance of a method embodying the present invention is stored in a data storage 20, which also comprises one or more memory devices. During performance of a method embodying the present invention, program steps are fetched from the program storage 30 and executed by a Central Processing Unit (CPU) 10, retrieving data as required from the data storage 20. Output information resulting from performance of a method embodying the present invention can be stored back in the data storage 20, or sent to an Input/Output (I/O) interface 40, which includes a network interface for sending and receiving data to and from other network nodes and which may also include a radio transceiver for communicating with one or more terminals.

Accordingly, in various embodiments, processing circuits, such as the CPU 10 and memory circuits 20 and 30 in FIG. 25, are configured to carry out one or more of the techniques described in detail above. Likewise, other embodiments may include radio network controllers including one or more such processing circuits. In some cases, these processing circuits are configured with appropriate program code, stored in one or more suitable memory devices, to implement one or more of the techniques described herein. Of course, it will be appreciated that not all of the steps of these techniques are necessarily performed in a single microprocessor or even in a single module.

It will be appreciated by the person of skill in the art that various modifications may be made to the above described embodiments without departing from the scope of the present invention. For example, although embodiments of the present invention have been described with examples that include a communication system compliant to the 3GPP specified LTE standard specification, it should be noted that the solutions presented may be equally well applicable to other networks that support dual connectivity. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

Embodiments of the inventive techniques and apparatus described above include, but are not limited to: A first network node operable to: request a second network node to configure radio resources for communication with a wireless device according to a multiple connectivity configuration, wherein the first network node acts as a master node and the second network node acts as a secondary node, the request comprising: (optionally) a target quality of service for the communication; (optionally) device capability information associated with the wireless device; and a target radio resource configuration that the first network node intends to apply during the multiple connectivity communication.

As an example, the first network node may be configured as an MeNB and the second network node may be configured as an SeNB in a dual-connectivity mode. The MeNB may send the request to add or modify the radio configuration of the SeNB. As an example, the MeNB may send the request to add the second network node as an SeNB based on an RRM measurement received from the wireless device. In the request, the target quality of service information may comprise E-RAB parameters or other suitable parameters (e.g., guaranteed bit rates, priority, packet delay budget, packet error loss rate, etc.). The target quality of service may be determined by a subscription/contract associated with the wireless device in some embodiments. The device capability information may comprise information for coordinating the radio configurations of the first network node and the second network node so as to not overwhelm the capabilities of the wireless device during dual/multiple connectivity mode. For example, the device capability information may indicate features supported (or not supported) by the wireless device or capability limits associated with the wireless device (maximum buffer sizes, maximum number of bits per subframe, etc.). Some examples of device capabilities that may be described in the device capability information are provided above.

In some embodiments, it may be optional for the first network node to send the target quality of service and/or the device capability information in the request. For example, first network node may not need to send information that SeNB has previously received.

The SeNB may use the target quality of service, the device capability information, and the target radio resource configuration that the first network node intends to apply (e.g., the master target radio resource configuration) in order to determine the SeNB's radio resource configuration. The SeNB may configure its radio resources so that when operating in multiple connectivity mode with the MeNB, the target quality of service is met and the capabilities of the wireless device are not exceeded. Because the SeNB knows the target configuration that the MeNB intends to apply (which may be different than the current configuration of the MeNB), the SeNB may be better able to coordinate a configuration that will complement the target configuration of the MeNB in the sense that together the SeNB and MeNB may meet the target quality of service without exceeding the capabilities of the wireless device.

The first network node of the first embodiment, may further be operable to: receive a target radio resource configuration that the second network node intends to apply during the multiple connectivity communication; and modify the target radio resource configuration that the first network node intends to apply during the multiple connectivity communication based on the target radio resource configuration that the second network node intends to apply.

In some embodiments, the MeNB may endorse the SeNB configuration, (optionally) add possible changes to MeNB's own configuration, and send a message to the wireless device (such as a RRCconnectionReconfiguration message) to apply the configuration. In some embodiments, an inter node RRC information element AS-Config may be used to covey the radio resource configuration in the request to the second network node (in embodiment 1) and/or in the response from the second network node (in embodiment 2). Once the target radio configuration has been negotiated (which may or may not include modifying the MeNB target radio resource configuration and/or rejecting the SeNB target radio configuration to cause the SeNB to select a different SeNB target radio configuration), MeNB may send the negotiated MeNB and SeNB target radio configurations to the wireless device.

The first network node of any of the embodiments above, may further be operable to: receive a target radio resource configuration that the second network node intends to apply during the multiple connectivity communication; and send a rejection to the second network node rejecting the target radio resource configuration that the second network node intends to apply.

In some embodiments, the rejection could include an indicator that provides a reason for the rejection. As an example, the reason may be that the combination of the MeNB's configuration and the target radio resource configuration that the second node (SeNB) intends to apply would exceed the capabilities of the wireless device, fail to meet the target quality of service, or both. In some embodiments, the rejection may include an update to the target radio resource configuration that the first network node intends to apply (e.g. if the target radio resource configuration has changed).

The first network node of any of the above embodiments may further be operable to: determine that a configuration of the first network node has changed; and in response to determining that the configuration of the first network node has changed, send a configuration update message informing the second network node of the current configuration of the first network node.

For example, the MeNB could push changes in its configuration to the SeNB as the changes occur so that the SeNB can adjust its configuration when the MeNB's configuration changes. As an example, if resources of wireless device are released by the change in the MeNB's configuration, the SeNB may change the SeNB's configuration to make use of the now available resources. In some embodiments, the SeNB may push changes in its configuration to the MeNB.

The first network node of any of the above embodiments may further be operable to: determine a resource of the wireless device to be shared between the first network node and the second network node; and send an indicator to the second network node that indicates a portion of the resource allocated to the second network node.

As an example, in some circumstances, the resource to be shared may correspond to the L2 buffer size or the max amount of bits transmitted per subframe. In some embodiments, the MeNB may indicate explicitly to the SeNB how much of the shared wireless device capabilities the SeNB can use. This indicator could possibly be included in a separate information element of the request described in the first embodiment (e.g., an SeNB addition/modification request message). Or, the indicator could be sent to the second network node after sending the second network node the request to configure radio resources for communication with the wireless device according to a multiple connectivity configuration (e.g., after sending the SeNB addition/modification request message). Thus, in some embodiments, the MeNB may determine the resource allocation and send the indicator after the MeNB and the SeNB have selected their respective configurations (such as the number of carriers selected) so that the resource allocation can be made according to the respective configurations. As an example, the maximum number of bits transmitted per subframe could be split according to the number of established carriers in the MeNB and the SeNB respectively.

The embodiments described above may allow for negotiating radio resource configurations for dual/multiple connectivity. In some embodiments, the MeNB may optionally gather statistics associated with the negotiation (such as statistics indicating that the SeNB has utilised resources used by the MeNB in the current configuration and released in the MeNB target configuration, statistics indicating that the SeNB target configuration has violated the device capability of the wireless device (and/or a number of times that the SeNB target configuration has violated the device capability of the wireless device).

Embodiments herein relates to a secondary network node operable to receive a request from a master network node to configure resources for communication with a wireless device according to a multiple connectivity configuration, the request comprising: a target quality of service for the communication; device capability information associated with the wireless device; and a master target configuration that the master network node intends to apply during the multiple connectivity communication; and select a secondary target configuration that the secondary network node intends to apply during the multiple connectivity communication, the secondary target configuration selected to meet the target quality of service without exceeding the device capability of the wireless device when the master network node is configured according to the master target configuration.

Thus, in some embodiments a procedure is provided for negotiating MeNB and SeNB radio resource configurations during dual connectivity setup or modification. The procedure may include a method for ensuring that the SeNB is able to maximise the use of the UE's capabilities taking into account the MeNB configuration that would result from the dual connectivity setup/modification action, while ensuring that eRAB QoS requirements are fulfilled and UE capabilities are not exceeded. Although the preceding embodiments have been described for example purposes, it will be appreciated that other example embodiments include variations of and extensions to these enumerated examples, in accordance with the detailed procedures and variants described above.

In the above-description, the terminology used is for the purpose of describing particular embodiments only and is not intended to be limiting. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealised or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, some embodiments may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of present disclosure. Accordingly, the above disclosed subject matter is to be considered illustrative, and not restrictive, and the appended examples of embodiments are intended to cover all such modifications, enhancements, and other embodiments, which fall within the spirit and scope of present disclosure. Thus, the scope of present disclosure are to be determined by the broadest permissible interpretation of the present disclosure, and shall not be restricted or limited by the foregoing detailed description.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method performed by a Master evolved Node B, MeNB, in a wireless communication system, the wireless communication system being adapted to provide for dual connectivity between a User Equipment, UE, and the MeNB and the UE and a Secondary eNB, SeNB, the method being for modifying a radio resource of the SeNB, with respect to the UE currently being connected to the MeNB, the method comprising:
transmitting, to the SeNB, a request for radio resource modification with regards to an SeNB radio resource configuration between the SeNB and the UE, the request comprising a target MeNB radio resource configuration, and
receiving, from the SeNB, the SeNB radio resource configuration with regards to the radio resource between the SeNB and the UE.

2. A method according to claim 1, wherein the request for radio resource modification further comprises Radio Access Bearer, RAB, parameters, and UE capabilities when modifying the radio resource of the SeNB comprises adding a RAB between the SeNB and the UE.

3. A method according to claim 1, further comprising verifying that the SeNB radio resource configuration meets the UE capabilities, and transmitting the SeNB radio resource configuration and the target MeNB radio resource configuration to the UE when the SeNB radio resource configuration meets the UE capabilities.

4. A method according to claim 3, further comprising modifying the target MeNB radio resource configuration and transmitting the SeNB radio resource configuration and the modified target MeNB configuration to the UE.

5. A method according to claim 1, further comprising verifying that the SeNB radio resource configuration meets the UE capabilities, and transmitting a rejection of the SeNB radio resource configuration to the SeNB, when the SeNB radio resource configuration does not meet the UE capabilities.

6. A method according to claim 5, wherein the rejection comprises an updated target MeNB radio resource configuration.

7. A method according to claim 1, wherein transmitting the target MeNB radio resource configuration comprised in the request for radio resource modification, to the SeNB, is performed by means of Radio Resource Configuration, RRC, information element AS-Config.

8. A method according to claim 3, further comprising incrementing a first counter for the SeNB when the MeNB successfully verifies that the SeNB configuration meets the UE capabilities and/or incrementing a second counter whenever the SeNB configuration violates the UE capabilities.

9. A method performed by a Secondary evolved Node B, SeNB, for modifying a radio resource of the SeNB, with respect to a User Equipment, UE, currently being connected to a Master eNB, MeNB, the SeNB being operable in a wireless communication system, the wireless communication system being adapted to provide for dual connectivity between the UE and the MeNB and the UE and the SeNB, the method comprising:
receiving, from the MeNB, a request for radio resource modification with regards to a radio resource between the SeNB and the UE, the request comprising a target MeNB radio resource configuration,
determining an SeNB radio resource configuration between the SeNB and the UE based on the received target MeNB radio resource configuration, and
transmitting, to the MeNB, the determined SeNB radio resource configuration.

10. A method according to claim 9, wherein the request for radio resource modification further comprises Radio Access Bearer, RAB, parameters, and UE capabilities, when modifying the radio resource of the SeNB with respect to the UE comprises adding a RAB between the SeNB and the UE.

11. A method according to claim 10, wherein determining the SeNB radio resource configuration with respect to the UE further is based on the received UE capabilities and RAB parameters.

12. A method according to claim 9, further comprising
receiving, from the MeNB, a new request for radio resource modification with regards to the radio resource between the SeNB and the UE, or a rejection of the SeNB radio resource configuration,
determining a new SeNB radio resource configuration between the SeNB and the UE based on the received target MeNB radio resource configuration, and
transmitting, to the MeNB, the new SeNB radio resource configuration.

13. A method according to claim 12, wherein the new request for radio resource modification further comprises an updated received target MeNB radio resource configuration, wherein determining the new SeNB radio resource configuration is based on the received updated target MeNB radio resource configuration.

14. A Master evolved Node B, MeNB, in a wireless communication system, the wireless communication system being adapted to provide for dual connectivity between a UE and a MeNB and the UE and a SeNB, the MeNB being configured for modifying a radio resource of a Secondary eNB, SeNB, with respect to a User Equipment, UE, currently being connected to the MeNB, the MeNB being configured for:
transmitting, to the SeNB, a request for radio resource modification with regards to an SeNB radio resource configuration between the SeNB and the UE, the request comprising a target MeNB radio resource configuration, and
receiving, from the SeNB, the SeNB radio resource configuration with regards to the radio resource between the SeNB and the UE.

15. An MeNB according to claim 14, wherein the request for radio resource modification further comprises Radio Access Bearer, RAB, parameters, and UE capabilities when the MeNB is configured for modifying the radio resource of the SeNB by adding a RAB between the SeNB and the UE.

16. An MeNB according to claim 14, further being configured for verifying that the SeNB radio resource configuration meets the UE capabilities, and for transmitting the SeNB radio resource configuration and the target MeNB radio resource configuration to the UE when the SeNB radio resource configuration meets the UE capabilities.

17. An MeNB according to claim 16, further being configured for modifying the target MeNB radio resource configuration and for transmitting the SeNB radio resource configuration and the modified target MeNB configuration to the UE.

18. An MeNB according to claim 14, further being configured for verifying that the SeNB radio resource configuration meets the UE capabilities, and transmitting a rejection of the SeNB radio resource configuration to the SeNB, when the SeNB radio resource configuration does not meet the UE capabilities.

19. An MeNB according to claim 18, wherein the rejection comprises an updated target MeNB radio resource configuration.

20. An MeNB according to claim 14, wherein the MeNB is configured for transmitting the target MeNB radio resource configuration comprised in the request for radio resource modification, to the SeNB, by means of Radio Resource Configuration, RRC, information element AS-Config.

21. An MeNB according to claim 16, further being configured for incrementing a first counter for the SeNB when the MeNB successfully verifies that the SeNB configuration meets the UE capabilities and/or for incrementing a second counter whenever the SeNB configuration violates the UE capabilities.

22. A Secondary evolved Node B, SeNB, for modifying a radio resource of the SeNB, with respect to a User Equipment, UE, currently being connected to a Master eNB, MeNB, the SeNB being operable in a wireless communication system, the wireless communication system being adapted to provide for dual connectivity between the UE and the MeNB and the UE and the SeNB, the SeNB being configured for:
receiving, from the MeNB, a request for radio resource modification with regards to a radio resource between the SeNB and the UE, the request comprising a target MeNB radio resource configuration,
determining an SeNB radio resource configuration between the SeNB and the UE based on the received target MeNB radio resource configuration, and
transmitting, to the MeNB, the determined SeNB radio resource configuration.

23. An SeNB according to claim 22, wherein the request for radio resource modification further comprises Radio Access Bearer, RAB, parameters, and UE capabilities, when the SeNB is configured for modifying the radio resource of the SeNB with respect to the UE by adding a RAB between the SeNB and the UE.

24. An SeNB according to claim 23, wherein the SeNB is configured for determining the SeNB radio resource configuration with respect to the UE further based on the received UE capabilities and RAB parameters.

25. An SeNB according to claim 22, further being configured for:
receiving, from the MeNB, a new request for radio resource modification with regards to the radio resource between the SeNB and the UE, or a rejection of the SeNB radio resource configuration,
determining a new SeNB radio resource configuration between the SeNB and the UE based on the received target MeNB radio resource configuration, and
transmitting, to the MeNB, the new SeNB radio resource configuration.

26. An SeNB according to claim 25, wherein the new request for radio resource modification further comprises an updated received target MeNB radio resource configuration, wherein the SeNB is configured for determining the new SeNB radio resource configuration based on the received updated target MeNB radio resource configuration.

27. (canceled)

28. (canceled)

29. (canceled)

30. (canceled)
